(19) United States
(12) Patent Application Publication
(10) Pub. No.: US 2019/0028414 A1
(43) Pub. Date: Jan. 24, 2019

(54) System And Method For Providing a Communications Layer to Enable Full Participation in a Distributed Computing Environment That Uses Multiple Message Types

(71) Applicant: n.io Innovation, LLC, Broomfield, CO (US)

(72) Inventors: James David Walker, Denver, CO (US); Matthew R. Dodge, Dana Point, CA (US); James A. Holmes, Broomfield, CO (US); Franky Martin, Boca Raton, FL (US)

(21) Appl. No.: 16/038,786

(22) Filed: Jul. 18, 2018

Related U.S. Application Data
(60) Provisional application No. 62/534,503, filed on Jul. 19, 2017.
(60) Provisional application No. 62/599,981, filed on Dec. 18, 2017.

(51) Int. Cl. H04L 12/58; H04L 29/08; H04L 29/06

(52) U.S. Cl. CPC H04L 51/066; H04L 51/38; H04L 63/0428; H04L 67/104; H04L 67/26; H04L 67/2823

(57) ABSTRACT

An improved system and method for communication among clients using multiple messaging types are disclosed. In one example, a client includes at least one brew that interfaces with a module. The module encapsulates a transfer mechanism for sending and receiving messages using a particular message type. The client further includes at least one brewer or patron, but may include many brewers and/or patrons, each of which corresponds to at least one topic. An application using the client can send messages to other clients using a standardized interface provided by all brewers and may receive messages from other clients either from patrons using a standardized interface provided by all patrons or from the brew.

### CROSS REFERENCE TO RELATED APPLICATIONS

This application claims the benefit of U.S. Provisional Application 62/534,503, filed on Jul. 19, 2017, and entitled SYSTEM AND METHOD FOR PROVIDING A COMMUNICATIONS LAYER TO ENABLE FULL PARTICIPATION IN A DISTRIBUTED COMPUTING ENVIRONMENT THAT USES MULTIPLE MESSAGE TYPES, and U.S. Provisional Application 62/599,981, filed on Dec. 18, 2017, and entitled SYSTEM AND METHOD FOR PROVIDING BRIDGING FOR A COMMUNICATIONS LAYER TO ENABLE FULL PARTICIPATION IN A DISTRIBUTED COMPUTING ENVIRONMENT THAT USES MULTIPLE MESSAGE TYPES, both of which are hereby incorporated by reference in their entirety.

### BACKGROUND

The proliferation of message types has caused difficulties in creating distributed systems in which all applications can fully participate. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a messaging system;

FIG. 1B illustrates one embodiment of a device within the system of FIG. 1A on which a server and/or at least one client are running;

FIG. 2 illustrates one embodiment of a client that may be used in the system of FIG. 1A;

FIG. 3A illustrates one embodiment of a stack representing different layers of the client of FIG. 2 and how those layers may interact with an application;

FIG. 3B illustrates another embodiment of the stack of FIG. 3A;

FIG. 4A illustrates one embodiment of how components within the client of FIG. 2 may interact;

FIG. 4B illustrates one embodiment of different communication routes for an application;

FIG. 5 illustrates one embodiment of a sequence diagram showing steps by which a client may operate within the messaging system of FIG. 1A;

FIG. 6 illustrates a more detailed embodiment of the messaging system of FIG. 1A from a signal/control perspective;

FIG. 7 illustrates one embodiment of a sequence diagram showing a process by which a client may be started for use within the message system of FIG. 1A;

FIG. 8 illustrates one embodiment of a flow chart representing a method for starting a client from an application's perspective;

FIG. 9 illustrates one embodiment of a flow chart representing a method for starting a client from the client's perspective;

FIG. 10 illustrates one embodiment of a sequence diagram showing a process by which clients may communicate with a server in order to communicate within the message system of FIG. 1A;

FIG. 11 illustrates one embodiment of a sequence diagram showing a process by which a client may authenticate with a server within the message system of FIG. 1A;

FIG. 12 illustrates one embodiment of the messaging system of FIG. 1A with clients supporting different message types;

FIGS. 13A and 13B illustrate embodiments of a sequence diagram and a flow chart, respectively, showing a process by which a client may begin sending data to another client within the message system of FIG. 1A;

FIGS. 14A and 14B illustrate embodiments of a sequence diagram and a flow chart, respectively, showing a process by which a client may begin receiving data from another client within the message system of FIG. 1A;

FIG. 15 illustrates one embodiment of a sequence diagram showing a process by which a server may attempt to synchronize receiving clients before they begin to receive data from another client within the message system of FIG. 1A;

FIG. 16 illustrates one embodiment of the messaging system of FIG. 6 from a data perspective;

FIG. 17 illustrates one embodiment of a sequence diagram showing a process by which a client may transfer data to another client within the message system of FIG. 1A;

FIGS. 18A-18D illustrate embodiments of flow charts representing methods for processing data by brews of FIG. 17;

FIG. 19 illustrates one embodiment of a portion of the message system of FIG. 1A with data for multiple topics being transferred from one client to another client;

FIG. 20 illustrates another embodiment of a portion of the message system of FIG. 1A with data for multiple topics being transferred from one client to two clients;

FIG. 21 illustrates a more detailed embodiment of a portion of the message system of FIG. 1A with data for multiple topics being transferred from one client to two clients using two different message types;

FIG. 22 illustrates one embodiment of a system within which an application uses a single client to communicate with multiple message systems;

FIG. 23 illustrates one embodiment of a system within which an application uses a separate client to communicate with each of multiple message systems;

FIG. 24 illustrates one embodiment of a system within which a bridge client converts and relays communications between two clients that cannot communicate directly;

FIGS. 25A and 25B illustrate a more detailed embodiment of the system of FIG. 24;

FIG. 26 illustrates one embodiment of a sequence diagram showing a process by which a single bridge segment may be established within the system of FIGS. 25A and 25B;

FIG. 27 illustrates a more detailed embodiment of the system of FIG. 24 with multiple bridge segments;

FIGS. 28A and 28B illustrate one embodiment of a sequence diagram showing a process by which multiple bridge segments may be established within the system of FIG. 27;

FIG. 29 illustrates one embodiment of a flow chart representing a method for establishing a bridge segment from a server's perspective;

FIG. 30 illustrates one embodiment of a flow chart representing a method for establishing a bridge segment from a bridge client's perspective;

FIGS. 31A and 31B illustrate one embodiment of a sequence diagram showing various processes by which disconnection may be handled for a bridge;

FIGS. 32A thru 32C and 33A and 33B illustrate embodiments of flow charts representing methods for dealing with disconnections in a bridge;

FIG. 34 illustrates one embodiment of a system in which multiple clients publish to a single bridge client;

FIG. 35 illustrates one embodiment of a system in which multiple clients receive data from a single bridge client;

FIG. 36 illustrates one embodiment of a system within which a gateway enables a device to fully participate in a message system when the device lacks the capability to do so itself; and

FIG. 37 illustrates one embodiment of a device that may be used to run a client and/or a server within the message system of FIG. 1A.

### DETAILED DESCRIPTION

The present disclosure is directed to a system and method for providing a communications layer to enable full participation in a distributed computing environment that uses multiple message types. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Communication systems, such as distributed computer systems, use many different messaging types to communicate. For example, Socket.IO, WebSocket, and publisher/subscriber models such as ZeroMQ, as well as other transmission control protocol (TCP), user datagram protocol (UDP) based communications, and other link layer transports like Bluetooth, Xbee, etc., all enable bi-directional communications and are commonly used. However, while similarities exist, different messaging types frequently work in different ways that make them incompatible with each other.

For example, Socket.IO may be configured to use “rooms” to manage data, with data written to and read from the rooms. Web Socket uses full-duplex communication channels over a single TCP connection. ZeroMQ may be used in many different configurations, including a push/pull configuration and a publisher/subscriber configuration that uses a broker to manage publishers and subscribers. TCP uses a model in which the receiver is notified where to connect to the sender to receive data. UDP uses a model in which the sender is notified where to send the data to the receiver. Accordingly, different message types have different requirements for the sender and/or receiver, and those requirements must be met for the message type to be properly implemented under the defined standards for that message type.

To enable a single application to use multiple messaging types, a developer or user will generally need to separately configure the application to handle each message type, as well as clarify which type is to be used for a given communication. This approach lacks flexibility and typically makes adding and/or removing message types a non-trivial process. This approach may also make it difficult to port code to another application, which may need its own message type configurations to work properly.

As more and more devices are integrated into increasingly large networks, the use of non-compatible message types imposes an increasingly large cost. For example, based on their available message types, some devices and/or applications may be excluded from consideration entirely, others may be selected but may require additional effort to implement a particular message type into their firmware or software, and others may be selected simply because of their message compatibility even though some of their parameters (e.g., processing speed, memory, power consumption, security, and/or feature set) are less than ideal.

Another issue with typical messaging types is that thin clients, such as web browsers, cannot directly interact with the network as a full client. This limits the thin clients' functionality and requires that thin clients either be avoided entirely or operate with limited functionality with a reduced number of compatible messaging types (e.g., WebSocket or other hypertext transfer protocol (http) based communications but not ZeroMQ).

In addition, even if a thin client can communicate within a network using Web Sockets or another compatible messaging type, there is generally no standardized process by which communications can be compartmentalized. For example, a standard Web Socket connection may be used to connect to a server and broadcast information to all clients, but there may be no way to direct the information only to certain clients without implementing customized solutions. Broadcasting generally causes increased network usage and requires additional processing power as each client determines if a message is needed by that particular client.

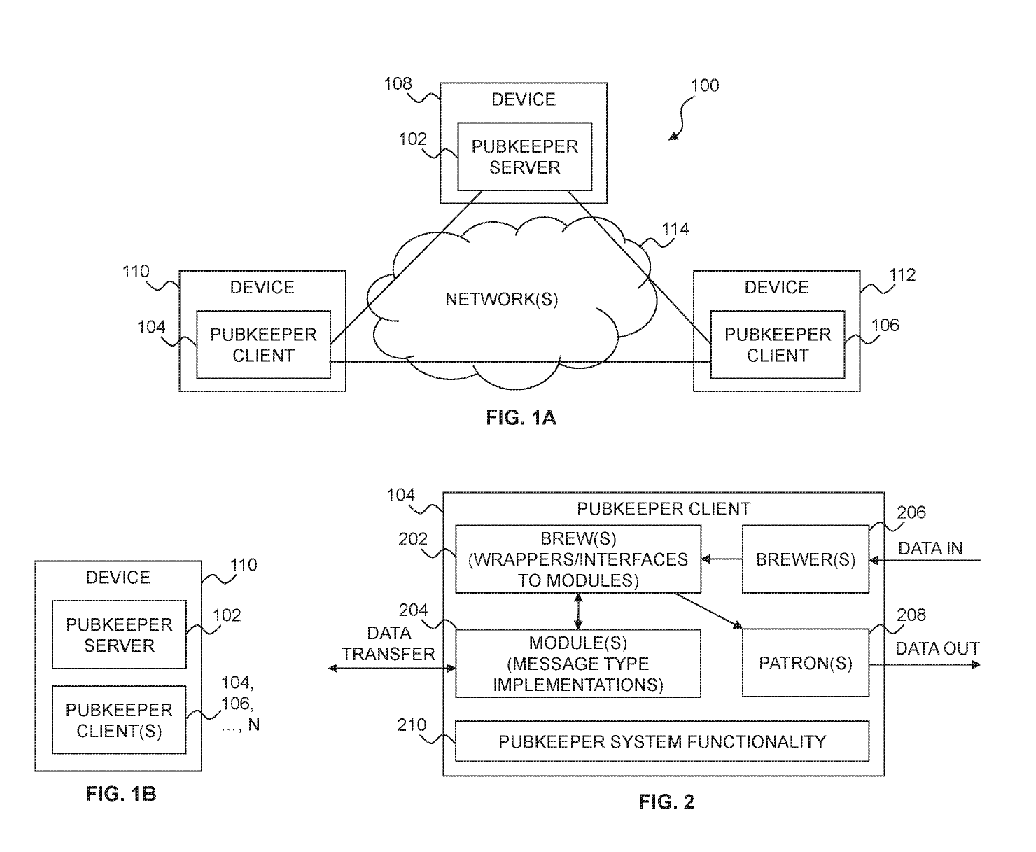

Referring to FIG. 1A, one embodiment of an environment 100 is illustrated in which a messaging system (which may be referred to herein as “Pubkeeper” or the “Pubkeeper system”) may be used to address the previously described issues. The Pubkeeper system provides an abstraction layer between different messaging mechanisms and any applications or components that are sending and/or receiving messages. The abstraction layer enables Pubkeeper to manage multiple messaging types while using a common interface to provide access to those message types regardless of the requirements of each message type.

To accomplish this, the Pubkeeper system provides one or more servers 102 that provide management functionality and endpoint clients 104 and 106 that handle client side messaging. While the server 102 is used to register the clients 104 and 106 and obtain initial communication information from the clients to facilitate communications between the clients, data does not go through the server 102 unless required by the particular message type being used. Instead, the clients 104 and 106 are responsible for ensuring that outgoing data is sent using the appropriate message type(s) and that incoming data is received and handled correctly.

As will be described in greater detail below, the manner in which data is sent between the clients 104 and 106 is based on the particular message type being used. For example, messages may be sent directly between clients (e.g., via ZeroMQ) or using an intermediary (e.g., a Socket.IO or Web Socket server) depending on the requirements of the particular message type being used. For purposes of this disclosure, a message type may represent a messaging system or library (e.g., ZeroMQ) and/or a particular protocol or standard (e.g., TCP, Bluetooth, or Xbee). In other words, a message type defines the mechanisms used to send and receive messages that are compatible with that message type.

Pubkeeper provides an abstraction layer that separates the user from the details of the message type. Using the Pubkeeper interface, an application developer or user can focus on their application's functionality and use common calls supported by Pubkeeper for sending and receiving messages, regardless of the underlying structure of a particular message type. Pubkeeper then manages the underlying communication layer to ensure that the messages are properly sent and/or received.

Pubkeeper clients can be written in different languages (e.g., Python, C++, Java, Go, or JavaScript) and/or for different operating systems and can communicate with each other as long as the selected message type is compatible. This is because the actual transfer mechanism between clients is fully compliant with the corresponding message type and is not altered by Pubkeeper. This means that Pubkeeper clients can be implemented for different operating systems and those clients will be compatible with any Pubkeeper system to which they all belong. This enables messaging functionality across operating systems without any additional effort by developers or users as long as a client can be run on each of the desired operating systems. Pubkeeper also provides full client functionality on platforms that would ordinarily not be able to participate as a full client (e.g., a web browser running a Pubkeeper JavaScript client can communicate either directly if the two Pubkeeper clients have a common message type or with other Pubkeeper clients via a bridge Pubkeeper client).

As illustrated in the environment 100 of FIG. 1A, the Pubkeeper system may be distributed on multiple devices (e.g., the devices 108, 110, and 112) that are coupled via a network 114. Examples of such devices include cellular telephones (including smart phones), personal digital assistants (PDAs), netbooks, tablets, laptops, desktops, workstations, single board computers, single board microcontrollers, embedded systems, and any other computing device that can communicate with another computing device using a wireless and/or wireline communication link.

Such communications occur through one or more networks 114 and may be direct (e.g., via a peer-to-peer network, an ad hoc network, or using a direct connection), indirect, such as through a server, gateway, or other proxy (e.g., in a client-server model), or may use a combination of direct and indirect communications. The network 114 may be a single network or may represent multiple networks, including networks of different types. For example, the device 110 may be coupled to the device 112 via a network that includes a cellular link coupled to a data packet network, or via a data packet link such as a wide local area network (WLAN) coupled to a data packet network. Accordingly, many different network types and configurations may be used to couple the devices 108, 110, and 112. It is understood that the devices 108, 110, and 112 themselves provide physical channels, but the server 102 and clients 104 and 106 that form the Pubkeeper system are shown with connections to each other to emphasize the communications within the Pubkeeper system.

With additional reference to FIG. 1B, it is understood that a single device (e.g., the device 110) may include the server 102 and one or more clients 104, 106, . . . , N. Furthermore, the server 102 may shift between devices based on availability, device parameters, network conditions, and/or other factors. For example, the first device in a Pubkeeper system may start the server 102, and the server may automatically be moved to another device later. In another embodiment, the server 102 may be assigned to a dedicated device.

Although a dedicated device may be used to host only the server 102, the server 102 may share a device with a client 104 in a Pubkeeper system. By avoiding the use of a dedicated device for the server 102, the Pubkeeper system may be more flexible as any capable device can host the server 102 (e.g., a device that has enough processing power, memory, and network bandwidth). Furthermore, by using the ability of the Pubkeeper system to switch which device is hosting the server 102, the Pubkeeper system is more resilient and may continue to operate despite device failures, localized network failures that affect only certain devices, and similar problems.

Accordingly, the Pubkeeper system provides a distributed messaging interface that enables applications to communicate using many different message types. By providing an application program interface (API) that exposes only needed functionality, Pubkeeper simplifies messaging and enables applications to focus on their own functionality while being integrated into the larger, multi-protocol messaging system that Pubkeeper enables.

Referring to FIG. 2, one embodiment of the client 104 of FIG. 1A is illustrated. The client 104 includes or is associated with one or more brews 202, one or more modules 204, and at least one brewer 206 or patron 208. In order to communicate within the Pubkeeper system, the client 100 needs at least one brew 202, at least one module 204 that corresponds to the brew 202, and at least one brewer 206 or patron 208. It is understood that some or all of the functionality provided by the various components may be combined (e.g., the brew 202 and the module 204 may be combined) or further separated into additional components.

Each Pubkeeper client is a generic manager that is able to operate within the Pubkeeper system (e.g., can communicate with the server 102) and provides a registration framework for its brews 202, brewers 206, and patrons 208.

A brew 202 is a wrapper for a particular module 204 and provides an interface between the module and brewers 206 and patrons 208. A module 204 is a particular implementation of a message type and may come in different forms. For example, ZeroMQ may be a module, as may a library that enables Web Socket communications. A module 204 may include various layers of a network stack (e.g., an HTTP layer, a TCP layer, and an IP layer), or may use the network stack provided by the operating system of the device on which the client 104 is running. Accordingly, a module 204 represents the actual send/receive mechanism for a particular message type and the corresponding brew 202 is a wrapper that provides a standardized interface (e.g., an API) for that module.

More specifically, a brew 202 provides a standardized interface for brewers 206 and patrons 208 that can be used to send and receive messages, respectively, with a module 204 regardless of the module's message type. For example, a standard call to a brew 202 from a brewer 206 may be used to send data and that brew 202 will be configured to accept the standard call and manage interactions with the module 204 in any way needed to accomplish the actual transmission of the data by the module 204. The brewers 206 and patrons 208 need not be concerned with the module's actual mechanics of sending or receiving messages, respectively, and only need to know the standardized set of interactions that are made available by all brews 202.

A brew 202 may also provide additional processing functionality, such as encryption/decryption. Although other components may be customized (e.g., brewers 206 may be configured to handle encryption and patrons 208 may be configured to handle decryption), the brew 202 will generally be the client component that handles customized processing. This ensures that the brewers 206, patrons 208, and modules 204 remain standardized.

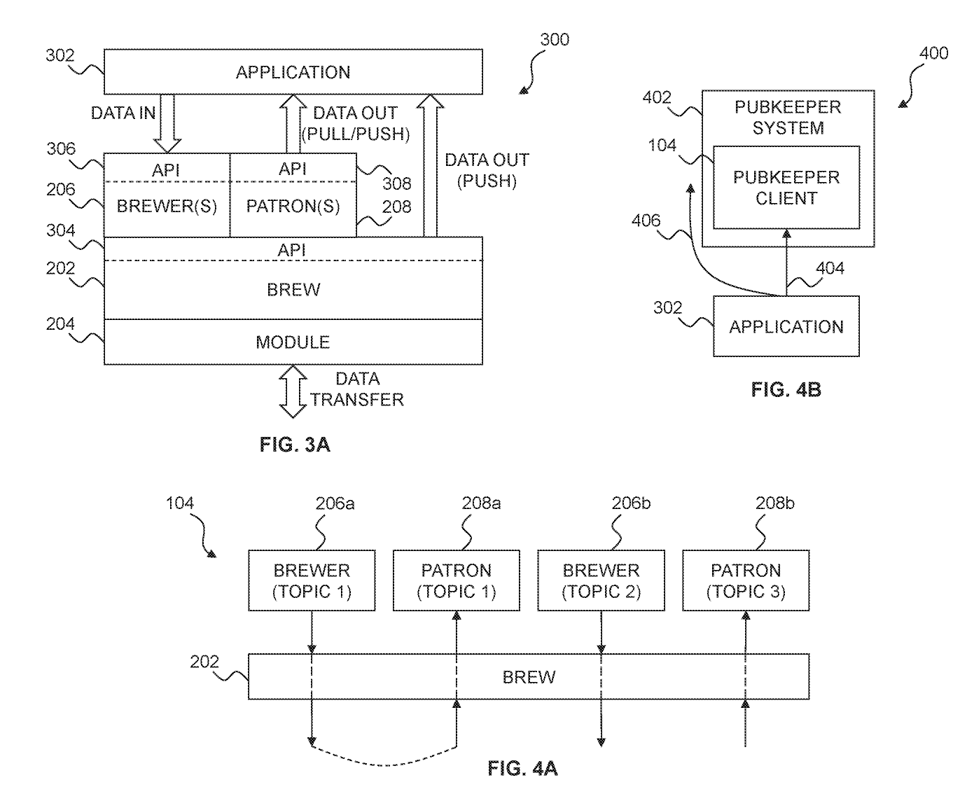

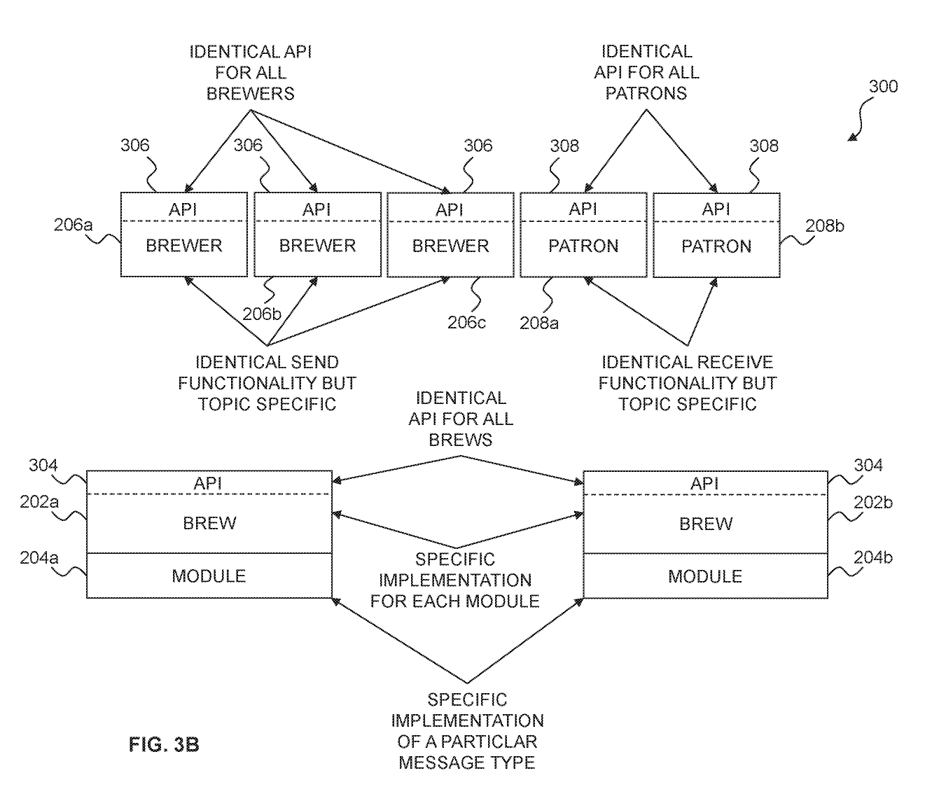

A brewer 206 exposes an API for use by applications in sending messages for a particular topic and a patron 208 exposes an API for receiving information by an application for a particular topic. In other words, a brewer 206 provides an interface between the brews 202 and data sources. A patron 208 provides an interface between the brews 202 and data destinations, although a brew 202 may communicate directly with a data destination in some embodiments (e.g., FIG. 3A). Accordingly, each brew 202 corresponds to a single module 204 and provides a standardized communications interface that is the same across all brews 202. This enables all brewers 206 and patrons 208 to interact with a brew 202 in the same manner regardless of the underlying module 204 that is managed by the brew.

As described, there is typically a one-to-one correspondence between modules 204 and brews 202, with each brew 202 corresponding to a single module 204. However, there may be a one-to-many correspondence between brews 202 and/or brewers 206/patrons 208, with each brew interacting with multiple brewers and/or patrons. By separating the APIs that brewers 206 and patrons 208 provide to applications from the API that the brews 202 provide to the brewers 206 and patrons 208, the brews 202 can be modified as needed (e.g., to address compatibility issues if the underlying module 204 is altered or to add additional processing functionality) without needing to change the brewers 206 and patrons 208.

System functionality 210 enables the client 104 to operate as part of a Pubkeeper system. For example, the system functionality 210 enables the client 104 to interact with the server 102 for authentication and registration purposes, both of which will be described below in greater detail. From one perspective, the system functionality 210 is the client 104, and the brews 202, modules 204, brewers 206, and patrons 208 are components of the client that interact with the system functionality as needed.

In some embodiments, the client 104 may be executed as a thread of an application that is using the client 104. The thread may run the system functionality 210 and the brews 202, modules 204, brewers 206, and patrons 208 may be run as other threads. In other embodiments, the client 104 may be a process running the system functionality 210, and the brews 202, modules 204, brewers 206, and patrons 208 may be run as threads of that process. In still other embodiments, some or all of the brews 202, modules 204, brewers 206, and patrons 208 may be run as their own processes.

With additional reference to FIG. 3A, one embodiment of a stack 300 illustrates the relationships between a brew 202, a module 204, brewer(s) 206, and patron(s) 208 as layers through which data passes to and from an application 302. It is understood that the “IN” and “OUT” are from the Pubkeeper client's perspective in FIG. 3A, and would be reversed from the perspective of the application 302.

The arrow labeled “DATA TRANSFER” is data that is being sent or received by the client on behalf of the application 302. The arrow labeled “DATA IN” represents data that has been received by the client 104 from the application 302 and is to be sent by the client.

Data that has been received by the client 104 from a data source (e.g., another application) can be sent to the application 302 using either a pull process or a push process. In the present example, the pull process moves the data from the brew 202 through the patron 208 to the application 302. This enables the patron 208 to provide queuing functionality for the brew 202. In other words, the brew 202 can push data to the patron 208, which can then queue the data until the application 302 is ready to pull it. This is represented by PULL part of the arrow labeled “DATA OUT (PULL/PUSH).” Because the application 302 can pull the data whenever there is data available and the application 302 is ready, thread safety is not generally an issue. In other embodiments, the patron 208 may be used by the brew 202 to decrypt the data before pushing it to the application 302. This is represented by PUSH part of the arrow labeled “DATA OUT (PULL/PUSH).”

Another push process bypasses the patron 208 and moves the data directly from the brew 202 to the application 302. For example, if the brew 202 is handling decryption, there may be no need to push the data through the patron 208. This is represented by the arrow labeled “DATA OUT (PUSH).” Because data structures may be shared between threads and the application 302 may receive pushed data at any time, thread safety is generally needed when data is pushed to the application 302.

Whether data is pushed directly from the brew 202 or through the patron 208 may depend on whether encryption is enabled. If encryption is not enabled, the brew 202 may push the data directly to the application 302 (although pushing through the patron 208 would still be possible). If encryption is enabled, whether data is pushed directly from the brew 202 or through the patron 208 may depend on which component is responsible for decryption. If the brew 202 is responsible for decryption, the brew 202 may push the data directly to the application 302 (although pushing through the patron 208 would still be possible). If the patron 208 is responsible for decryption, the brew 202 would need the patron 208 to decrypt the data being pushed. In such cases, the brew 202 may call the patron 208 for decryption and then send the data out itself or may simply push the data through the patron 208 following decryption.

It is understood that other embodiments may be configured for different data flows. For example, in one embodiment, the brew 202 may have queuing capabilities and the application 302 may be able to pull directly from the brew 202. In another embodiment, the patron 202 may have push capabilities and brew 202 may push to the patron 208, which may in turn push the data to the application 302. Accordingly, while many examples in the present disclosure use the patron 208 for pulling data and the brew 202 for pushing data, other configurations are also possible.

As illustrated, the actual send/receive mechanisms of the module 204 and brew 202 are shielded from the application 302, which uses a standard set of calls with brewer(s) 206 and/or patron(s) 208 in order to send or receive (e.g., pull) data. In turn, the brew 202 shields the brewer(s) 206 and patron(s) 208 from the module 204. The brewer(s) 206 and/or patron(s) 208 use a standard set of calls with the brew 202 to send or receive data via the module 204. Because data is only pushed to the application 302 by the brew 202 (and not pulled from the brew 202), there are no calls by the application 302 to the brew 202 as required for pulling data from the patron 208.

In the present example, there is a one-to-one correspondence between brews 202 and modules 204 within a client. Without a module 204, a brew 202 cannot send information, as the module handles the actual transmission/reception for that message type. Without a brew 202, the brewers 206 and patrons 208 will not be able to use the module 204 because the brewers 206 and patrons 208 rely on standardized calls to the brew 202. Accordingly, each brew 202 is designed specifically for a particular module 204. Without the brews 202, each brewer 206 and patron 208 would need to know how to use the module 204, which would complicate the construction and maintenance of brewers and patrons. In a client with multiple brews 202, the brewers 206 and patrons 208 would be even more complex.

The Pubkeeper system is designed to allow new brews 202 and modules 204 to be added without needing corresponding changes to Pubkeeper clients, brewers 206, patrons 208, and system functionality 210. It is understood that, in some embodiments, it may be desirable to make changes to the clients 104/106, brewers 206, and/or patrons 208 for one or more brews 202. However, such changes may reduce the flexibility of the Pubkeeper system and/or reduce Pubkeeper's uniformity across large and/or multiple deployments.

With additional reference to FIG. 3B, one embodiment of the stack 300 with an additional brew 202b and module 204b illustrates various similarities and differences between components. Each module 204a and 204b is different due to the different message types being implemented. Similarly, each brew 202a and 202b is different because each brew must interact with its corresponding module. However, both brews 202a and 202b expose an identical API that is used to interact with brewers and patrons.

All brewers 206a-206c have identical send functionality (“send” being from the application's perspective), but are topic specific. More specifically, the Pubkeeper system uses “topics” to track what data goes where. Topic specific data may be routed into corresponding publication/subscription channels, sent directly to particular destinations (e.g., rooms), or handled in many different ways depending on the particular message type used to send the data. All brewers 206a-206c expose an identical API that is used to interact with the application 302.

All patrons 208a and 208b have identical receive functionality (“receive” being from the application's perspective), but are topic specific. Both patrons 208a and 208b expose an identical API that is used to interact with the application 302. As shown, there may be different numbers of brewers 206 and patrons 208 within a client. It is understood that describing various components in this example as identical means that they have substantially similar functionality, as customized components may be integrated into the stack 300 if desired.

Referring to FIG. 4A, one embodiment of a brew 202 is illustrated with brewers 206a and 206b, and patrons 208a and 208b. The abstraction layers provided by brews 202 and brewers 206/patrons 208 enable the brew 202 to interact with its corresponding module (not shown) while brewers 206 and patrons 208 represent topics.

In the present example, the brewer 206a represents Topic 1 and the brewer 206b represents Topic 2. The patron 208a represents Topic 1 and the patron 208b represents Topic 3. Both brewers 206a and 206b and both patrons 208a and 208b are communicating using the same message type represented by the brew 202. However, by partitioning data into defined topics, the Pubkeeper system can maintain a single abstraction layer for a particular message type using the brew 202 while providing a more granular level of control over what data is being sent/received with respect to various destinations/sources using the brewer 206/patron 208 layer. This enables applications to restrict their sending/receiving to specific topics and/or specific destinations/sources while maintaining a common interface for actually sending and receiving the data for those topics or destinations/sources.

In the present example, a brewer 206 is limited to one topic and a patron 208 may be limited to one topic or may enable the use of wildcards to subscribe to more than one topic. However, it is understood that, in some embodiments, a brewer 206 and/or patron 208 may be configured to handle multiple topics.

As illustrated in FIG. 4A with respect to the brewer 206a and patron 208a, data may loop back to the same client based on topic. More specifically, the brewer 206a is sending data out for Topic 1 and the patron 208a is receiving data for Topic 1, which means that the patron 208a will receive the data being sent by the brewer 206a. Accordingly, internal communications (e.g., within an application) may be integrated into the same Pubkeeper system that is used for external communications as long as the internal communications are routed through the client 104. This ability to route internal application messages through the Pubkeeper system enables distributed systems to be built that do not differentiate between internal and external messaging, making it as easy to communicate with an external application (either on the same device or a different device) as within an application itself.

With additional reference to FIG. 4B, due to the flexibility provided by a Pubkeeper system 402 with respect to whether particular communications for an application 302 are routed through the Pubkeeper system 402, the application 302 may be easily configured to handle communications in many different ways. More specifically, Pubkeeper does not require an “all or nothing” approach with an application and allows selected communications to be routed through a Pubkeeper system. For example, while a web browser (e.g., the application 302) may use a JavaScript Pubkeeper client 104 to communicate with another Pubkeeper client (not shown) using Websockets (represented by line 404), the web browser 302 may also use other connections (e.g., Websocket or WebRTC) (represented by line 406) that do not pass through the client 104. Such other connections 406 would not be part of the Pubkeeper system 402 to which the client 104 belongs even though the Websocket communications 404 are part of the Pubkeeper system. However, the web browser 302 may choose to only use support provided by the client 104, in which case all connections from the web browser 302 would be fully integrated into the Pubkeeper system 402.

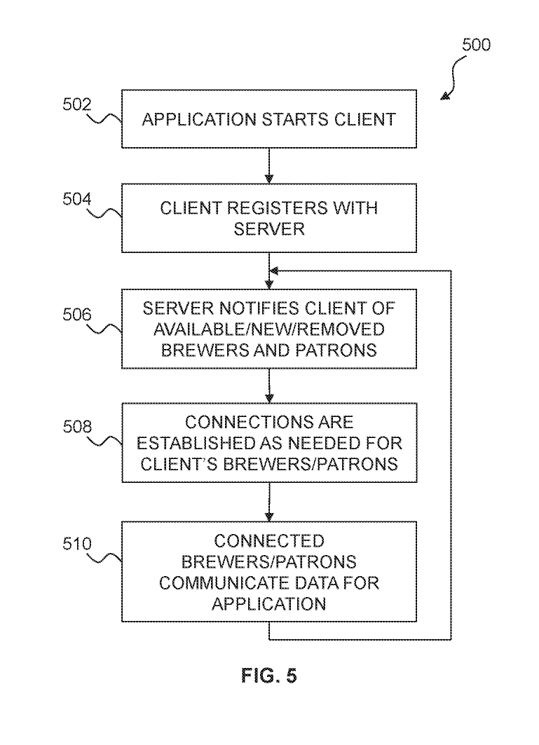

Referring to FIG. 5, a method 500 illustrates one embodiment of a process that may be performed within a Pubkeeper system for a Pubkeeper client (e.g., the client 104 of FIG. 1) to join and operate within the Pubkeeper system. More detailed examples of each step will be provided in following embodiments.

In step 502, an application (e.g., the application 302 of FIG. 3A) starts the client 104, which includes creating and configuring various options (e.g., the address and port information of the Pubkeeper server(s)) and components (e.g., brewer(s) 208 and/or patron(s) 208) of the client. In step 504, the client registers with the server 102.

In step 506, the server 102 sends the client 104 a list of only the brewers 206 and/or patrons 208 relevant to the client 104. For example, the server 102 may examine the client's registered brewers 206 and/or patrons 208 and return only the brewers 206 and/or patrons 208 that correspond to those registered by the client 104. In other embodiments, the server 102 may send the client 104 a list of all brewers 206 and patrons 208 that are available within the Pubkeeper system managed by the server 102.

In step 508, the client 102 establishes connections with the brewers 206 and/or patrons 208 in which the client is interested. In step 510, the client's brewers 206 and/or patrons 208 communicate with other brewers 206 and/or patrons 208 within the Pubkeeper system. Steps 506, 508, and 510 may repeat as the server 102 updates the client 104 whenever relevant brewers 206 and patrons 208 are added to and removed from the Pubkeeper system.

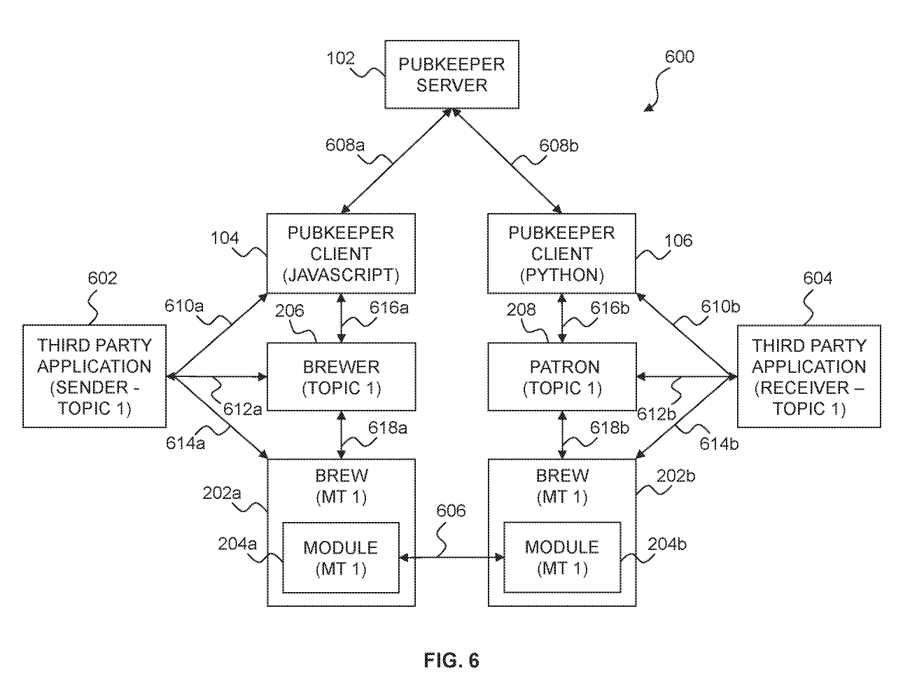

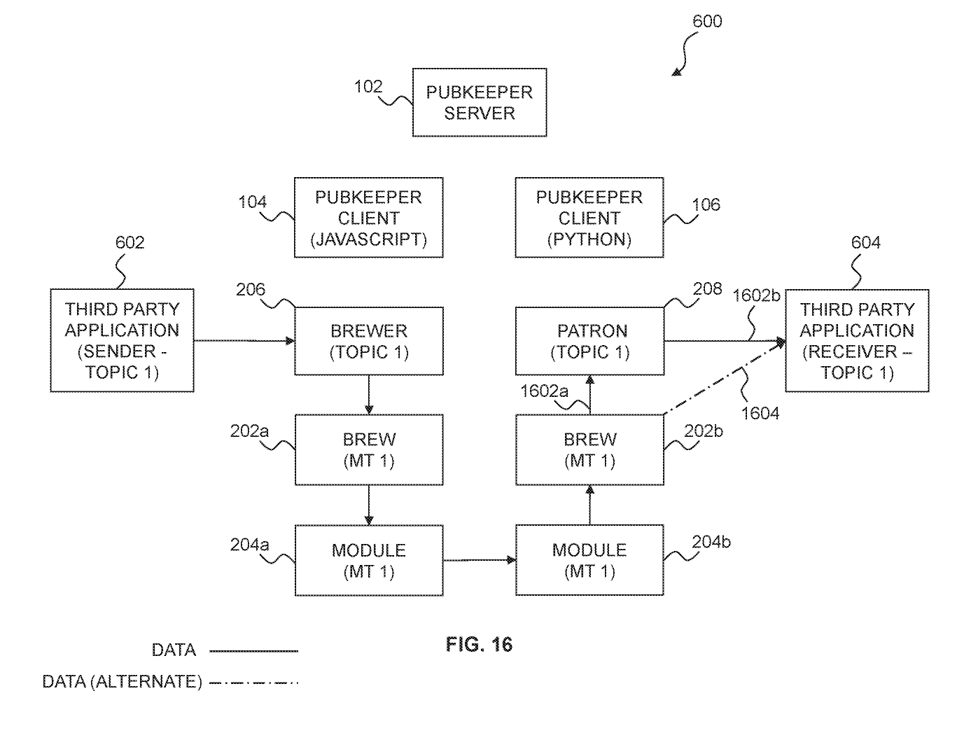

Referring to FIG. 6, one embodiment of a Pubkeeper system 600 is illustrated from a signal/control perspective with third party applications 602 and 604. A later embodiment (FIG. 16) illustrates the Pubkeeper system 600 from a data perspective. It is understood that some signaling may be dependent on the particular message type (e.g., between the modules 204a and 204b as illustrated by line 606 in order to establish a Web Socket connection or another connection type) and may not exist in all embodiments. Accordingly, FIG. 6 is largely directed to control signal paths within the Pubkeeper system 600 and between the Pubkeeper system 600 and the applications 602 and 604. Such control signals include instructions and/or messaging needed to start and maintain pubkeeper clients, client/server communications, and internal client communications.

The applications 602 and 604 are not part of the Pubkeeper system 600, but it is understood that in some embodiments one or both of the clients 104 and 106 may be embedded in the applications 602 and 604, respectively, or the applications may otherwise contain or include the clients. However, the applications 602 and 604 would generally use the same interfaces provided by their respective client, brewers, and patrons regardless of how the clients are implemented with respect to the applications. In some alternate embodiments, certain interfaces may be removed or replaced and an application may communicate with a client in different ways (e.g., if some or all of the functionality of the client is written into the application itself).

Although the clients 104 and 106 are shown as separate from their respective brews 202, modules 204, and brewers 206/patrons 208, the separation is merely to illustrate the interaction between the clients 104 and 106 and the components that are included within or are otherwise part of each client. Similarly, from the signaling perspective of FIG. 6, the brews 202a and 202b are illustrated as wrappers for their respective modules 204a and 204b. From the data perspective that is discussed later with respect to FIG. 16, the brews 202a and 202b are illustrated as separate from their respective modules in order to better illustrate the flow of data through each client and its components.

For purposes of example, the client 104 is a JavaScript client and the application 602 is a web browser. The Pubkeeper client 104 enables the web browser, which would ordinarily be limited in its messaging interactions, to interact fully with the Pubkeeper system and any supported message types. The client 106 is a Python client and the application 604 is any application that may be installed on or used with a device. The application 602 is sending data for “Topic 1” to the application 604 via the Pubkeeper system 600. Accordingly, the client 104 includes a brewer 206 for Topic 1 and the client 106 includes a patron 208 for Topic 1. The selected message type (MT) is “MT 1,” which can be any message type supported by both of the clients 104 and 106 (e.g., Web Sockets, WebRTC, or any other message type).

Examples of the creation and/or purpose of the illustrated signal paths of FIG. 6 will be described in various embodiments below.

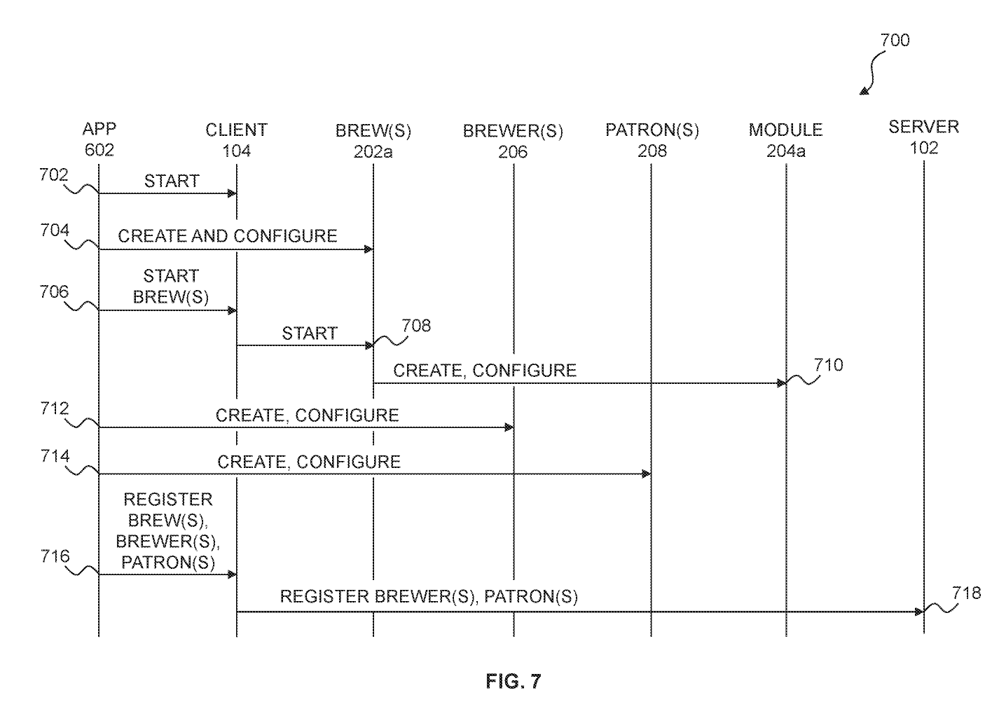

With additional reference to FIG. 7, a sequence diagram 700 illustrates one embodiment of a process by which the client 104 may be started and registered with the server 102 of FIG. 6. The process of FIG. 7 provides a more detailed example of steps 502 and 504 of FIG. 5 and describes signal paths 608a, 610a, 612a, and 614a of FIG. 6. While FIG. 7 is directed to the client 104, the client 106 would perform an identical process using signal paths 608b, 610b, 612b, and 614b of FIG. 6. It is understood that some steps may occur in a different order than that shown, depending on the particular startup sequence that takes place. For example, step 706 may occur later than shown.

In step 702, the application 602 starts the client 104. This may occur as part of the application's startup process if the client 104 is embedded or otherwise included within the application 602, or may be a separate process that is initiated by the application 602 during or after the application's own startup process. The start command may be formatted in many different ways and may include different type of information. For example, the command may be similar to “client.name=PubkeeperClient(token, config={ configuration information}).

The token is an authentication token (if needed) for use with the server 102. The configuration information may include such information as the IP/port information of the Pubkeeper server 102 (if not dynamically discovered or assigned), certificate information, connection timeout parameters, and brewer/patron information (from which brew information may be extracted). In some embodiments, the configuration information may include brew information that is separate from brewer/patron information.

The brew information, which may be automatically discovered in some embodiments, may identify all brews 202 that are available to the client 104 and any needed information to use each brew. For example, a Web Socket brew 202 may be associated with IP/port information for a WebSocket server. In embodiments where the brews 202 are automatically discovered on startup, one or more locations where brews are stored may be provided to the client 104 or the client may simply scan default locations for available brews.

In step 704, the application 602 creates and configures each brew (including the brew 202a of FIG. 6) that is available to the client 104. For example, the application may create a brew using a particular name and assign a module to the brew using websocket_brew=WebsocketBrew. In step 706, the application 602 instructs the client 104 to start the brews 202, which the client 104 does in step 708. These steps determine which message types will be available to the client 104. Because the brews 202 are wrappers for their respective modules 204, the brew 202a starts the corresponding module 204a (for websockets in this example) in step 710. At this point, the brew 202a does not have information about any brewers or patrons and may be considered “inactive,” although it is ready to be used.

In steps 712 and 714, the application 602 starts any needed brewers 206 and patrons 208, respectively. For example, the application 602 may create the brewer 206 using brewer_name=Brewer('topic.name'). A unique brewer ID is assigned to the brewer 206 within the client 104. With respect to FIG. 6, only the brewer 206 would be started as no patrons are illustrated for the client 104 and step 714 would be omitted. Steps 712 and 714 also provide the application 602 with the information needed to send/receive data for specific topics. For example, by creating the brewer 206 with the desired topic, the application 602 will know to send data for that topic to the brewer 206.

In step 716, the application 602 registers the brews 202, brewers 206, and patrons 208 with the client 104. For example, the application 602 may register the brew 202 with the client 104 using client.add_brew(websocket_brew) and may register the brewer 206 using client.add_brewer(brewer_name).

It is understood that registration may occur immediately after each brew 202, brewer 206, and/or patron 208 is created, rather than in the order illustrated in FIG. 7. For example, the websocket_brew may be registered immediately following step 704, rather than in step 712, and the brewer 206 may be registered immediately following step 708. It is understood that a brewer 206 or patron 208 is generally created after any brews 202 that are to be used. Otherwise the information for a later created brew 202 will need to be passed to the brewer 206 and/or patron 208, which complicates the startup process.

In step 718, the client 104 registers the brewers 206 and the patrons 208 with the server 102. Step 718 may also be used to notify the server 102 of the client's brews 202 based on the registered brewers 206 and patrons 208, although this information may be explicitly relayed to the server 102 in the same step or a separate step.

Although not shown, the client 106 would perform the same basic startup process as that of the client 104, including the use of the websocket brew. However, rather than creating and registering the brewer 206, the client 106 would create the patron 208 (e.g., “patron_name=Patron('topic.name')” with the same topic as the brewer 206) and then register the patron 208 (e.g., “client.add_patron(patron_name)”). A unique patron ID would be assigned to the patron 208 within the client 106.

Although the application 602 is responsible for most of the initial startup processes in the present example, the client 104 may have more responsibility in other embodiments. For example, the application 602 may start the client 104 in step 702 and the client 104 may then initiate and perform steps 704, 708, 710, 712, and 714 without any additional instructions from the application 602. In such embodiments, the client 104 may then report any needed information to the application 602. Such information needed by the application 602 would include how to send data for Topic 1 to the brewer 206.

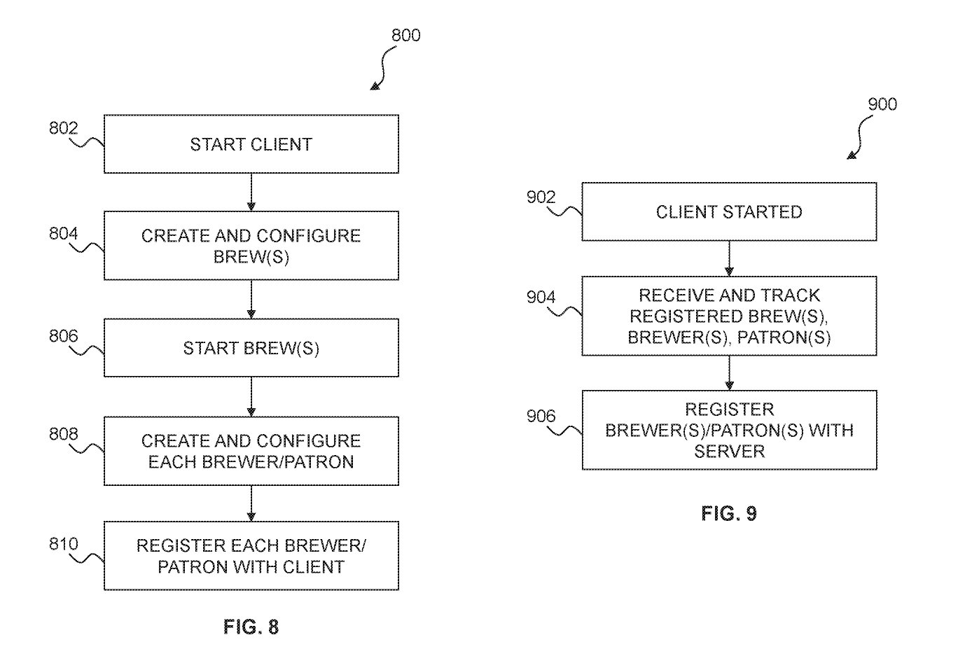

Referring to FIG. 8, a method 800 illustrates one embodiment of the process of FIG. 7 from the perspective of the application 602. In step 802, the application 602 starts the client 104. In step 804, the application 602 creates and configures any brews 202. In step 806, the application 602 instructs the client 104 to start the brews 202. The method 800 then continues to step 808 where each brewer 206 and patron 208 to be used by the client 104 is created. In step 810, each brewer 206 and patron 208 is registered with the client 104. It is understood that the steps 808 and 810 may overlap and/or repeat, with brewers 206 and patrons 208 being created and registered until no more remain to be created or registered.

Referring to FIG. 9, a method 900 illustrates one embodiment of the process of FIG. 7 from the perspective of the client 104. In step 902, the client 104 is started. In step 904, the client 104 receives registration information from the application 602. This registration information is used to track the brews, brewers, and/or patrons associated with the client. In step 906, the brews, brewers, and/or patrons are registered with the server 102.

It is understood that there are many different ways to order and track the clients and their brews, brewers, and patrons within the Pubkeeper system 600. In the present example, the server 102 keeps track of all clients, brews, brewers, and patrons within the Pubkeeper system 600, and each client keeps track of its own brews, brewers, patrons, and the clients, brewers, and patrons with which it is communicating. For example, a client may keep a record of all topics, the brewers and patrons for each topic, and the brews available for each brewer and patron as follows:

```
brewers {
      topic_1 {
            brewer_ID_123: [
                  {
                        name: websocket
                        host: 127.0.0.1
                        port: 9001
                        encryption: encryption_key
                  },
                  { name: zmq
                        publish:
                  }]
            client: resource to socket
      }
      topic_2 {
            brewer_ID_124: [
                  {
                        name: websocket
                        host: 127.0.0.1
                        port: 9002
                        encryption: encryption_key
                  },
                  { name: zmq
                        publish:
                  }
      ]
            client: resource to socket
      }
}
patrons {
      topic_3 {
            patron_ID_128: [
                  {
                        name: websocket
                        host: 127.0.0.1
                        port: 9011
                        encryption: encryption_key
                  },
                  { name: zmq
                        publish:
                  }]
            client: resource to socket
      }
```

In other embodiments, each client may receive a list of all brewers and patrons in the Pubkeeper system, even for currently inactive brewers and patrons.

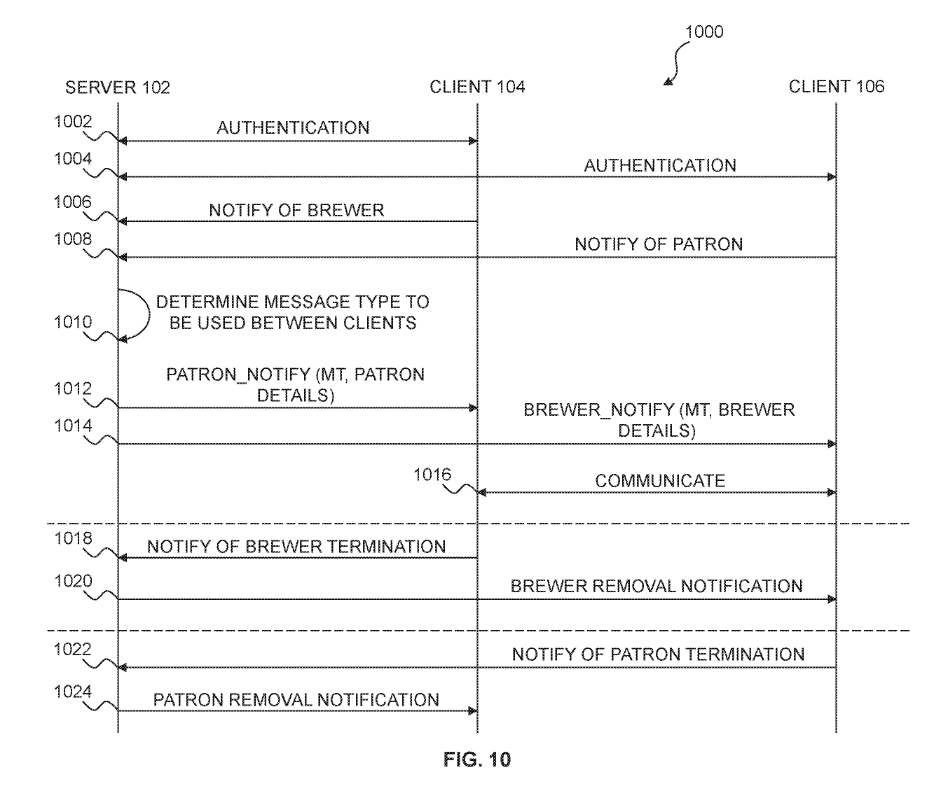

Referring to FIG. 10, a sequence diagram 1000 illustrates one embodiment of a process by which the client 104 may interact with the server 102 of FIG. 6. For each of the clients 104 and 106 to operate within the Pubkeeper system 600 and communicate with each other, the server 102 should recognize them as clients and the clients should know which message type to use with each other. The process of FIG. 10 provides a more detailed example of steps 504-512 of FIG. 5 and describes signal paths 608a and 608b of FIG. FIG. 6.

The clients 104 and 106 authenticate with the server 102 in steps 1002 and 1004, respectively. In some embodiments, actual authentication may not occur and steps 1002 and 1004 may represent simple registration where each client 104 and 106 notifies the server 102 that the client is online. However, for security reasons, the present embodiment requires authentication to ensure that only authorized clients are able to operate within the Pubkeeper system 600. It is understood that although the sequence diagram 1000 illustrates only a single brewer notification in step 1006 and a single patron notification in step 1008, multiple brewers and/or patrons may be notified by each client 104 and 106 during these steps.

With additional reference to FIG. 11, a sequence diagram 1100 illustrates one embodiment of a process by which the client 104 of FIG. 6 may authenticate with the server 102. In step 1102, the client 104 sends an authentication request to the server 102. For example, the client 104 may be configured with an encryption token (e.g., a JavaScript Object Notation (JSON) Web Token (JWT)) issued or otherwise recognized by the server 102 and may present the token to the server 102. In step 1104, the server 102 determines whether the client 104 is to be authenticated (e.g., whether the client's JWT is valid for the Pubkeeper system 600). Even if the token is valid, the token may be associated with particular privileges within the Pubkeeper system 600 and, if so, the server 102 would limit the actions of the client 102 to comply with those privileges.

In step 1106, the server 102 responds to the client 104 and either grants or denies the authentication request. The response may also provide information on the client's privileges within the Pubkeeper system 600. In step 1108, if the request is granted, a secure channel may be established (if such a channel was not established during the authentication process) between the server 102 and the client 104. The secure channel is used for notifications, heartbeats, and/or other messages between the server 102 and the client 104.

Referring again to FIG. 10, after authentication, the clients 104 and 106 register their brews, brewers, and/or patrons with the server 102 in steps 1006 and 1008, respectively. It is understood that the registration may occur as part of the authentication process of steps 1002 and 1004. For purposes of example, the client 104 registers the brewer 206 (FIG. 6) and the client 106 registers the patron 208.

At this point, because the client 104 has registered the brewer 206 for Topic 1 and the client 106 has registered the patron 208 for Topic 1, the server 102 is able to identify that the two clients will need to communicate. Accordingly, in step 1010, the server 102 determines which message type should be used between the two clients 104 and 106. In the present example, the server 102 makes this decision because it is aware of all the brewers 206 and patrons 208 within the Pubkeeper system 600, and can optimize the number of message types being used and therefore minimize the amount of the client resources needed for the connections.

At some point, the client 104 and/or the client 106 may completely disconnect or may at least terminate their corresponding brewer or patron. As shown in step 1018, if the brewer is terminated, the client 104 may notify the server 102 of the brewer termination. In step 1020, the server 102 may then send a brewer removal notification to the client 106. As shown in step 1022, if the patron is terminated, the client 106 may notify the server 102 of the patron termination. In step 1024, the server 102 may then send a patron removal notification to the client 104.

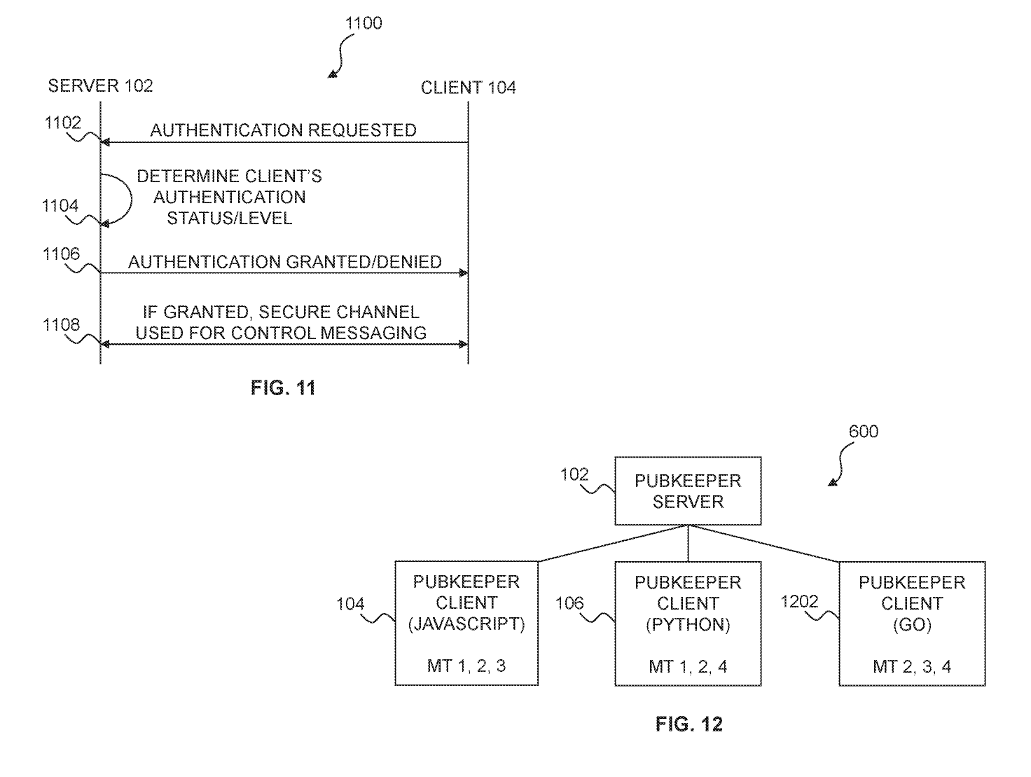

With additional reference to FIG. 12, a simplified diagram of the Pubkeeper system 600 of FIG. 6 is illustrated with the client 104 capable of communicating with message types 1, 2, and 3, and the client 106 capable of communicating with message types 1, 2, and 4. Another client 1202 (not shown in FIG. 6) is also present and is capable of communicating with message types 2, 3, and 4.

Between the clients 104 and 106, the server 102 could choose either MT 1 or MT 2 and the two clients could communicate normally. Such a selection could be based on many different criteria, including a default message type for the entire Pubkeeper system 600 or a preferred message type for a particular type of client (e.g., MT 1 for JavaScript clients when possible). The server 102 may also be configured to consider existing connections. For example, if the client 102 is already using MT 1 for communications with other clients (not shown), the server 102 may select MT 1 for use between the clients 104 and 106 so that the client 104 can continue using the same message type.

The server 102 may also be configured to consider possible future connections as shown in FIG. 12. More specifically, the client 1202 can communicate with the client 104 using MT 2 or MT 3, and can communicate with the client 106 using MT 2 or MT 4. However, the only common message type for all three clients is MT 2, so the server 102 may select that message type for the clients 104 and 106 even if the client 1202 does not currently have brewers or publishers corresponding to the client 104 or 106. Accordingly, the server 102 may select a particular message type for use between the clients 104 and 106 based on many different criteria.

Returning again to FIG. 10, after determining the message type to be used between the clients 104 and 106 in step 1010, the server 102 notifies the clients of the available brewers 206 and patrons 208, as well as the selected message type, in steps 1012 and 1014, respectively. More specifically, continuing the example of steps 1006 and 1008, the server 102 sends a message to the client 104 that informs the client 104 of the selected message type, the patron 208, and any details needed to communicate with the patron 208 in step 1012. The server 102 sends a message to the client 106 that informs the client 106 of the selected message type, the brewer 206, and any details needed to communicate with the brewer 206 in step 1014. The two clients 104 and 106 can then communicate using that message type as shown in step 1016.

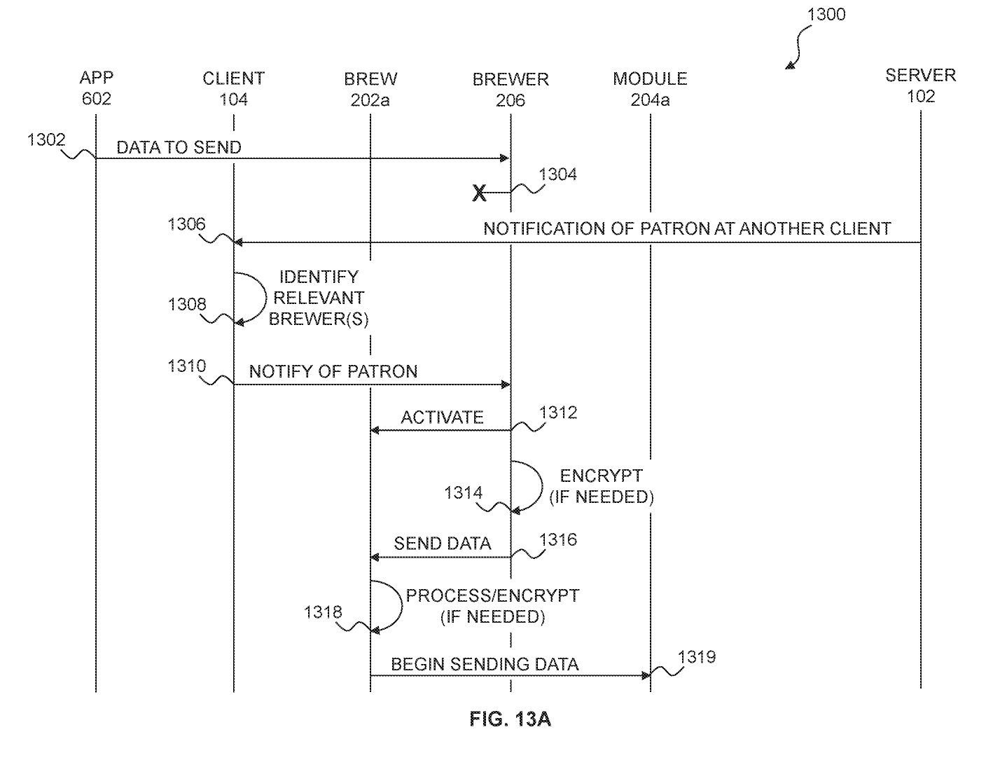

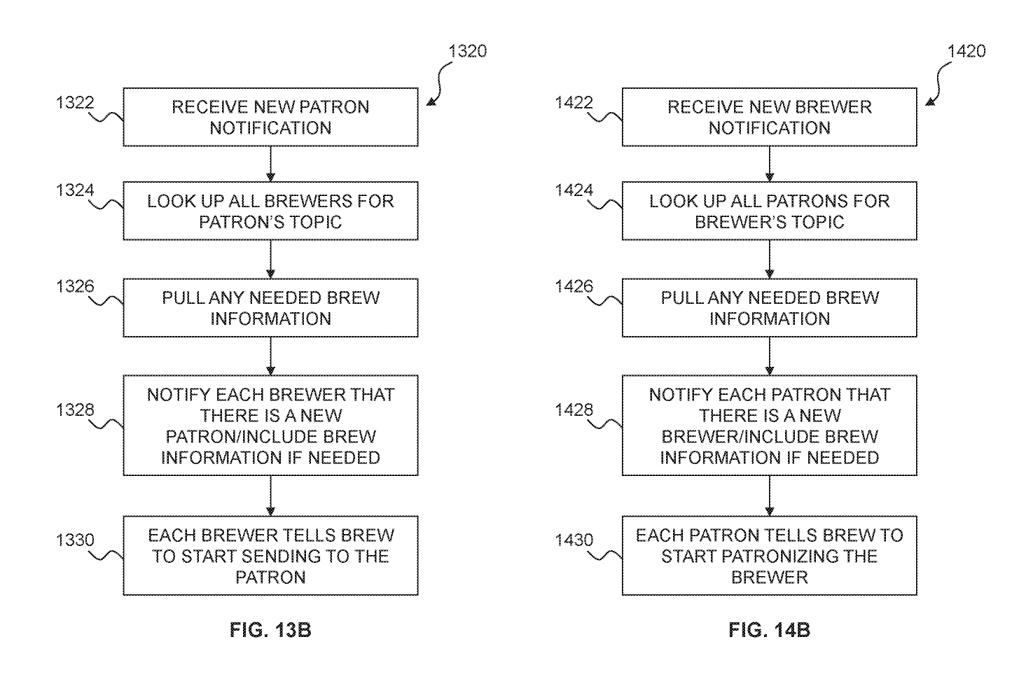

Referring to FIG. 13A, a sequence diagram 1300 illustrates one embodiment of a process by which the client 104 of FIG. 6 may send or not send data. Prior to step 1302, the client 104 has been started with the brewer 206, but there is no registered patron 208 corresponding to the brewer 206 (e.g., the patron 208 of FIG. 6 has not yet been registered).

Accordingly, with respect to steps 1302 and 1304, the brewer 206 (FIG. 6) is able to send information, but there is no patron 208 registered to receive the information. Depending on the configuration of the application 602, the application 602 may send data to the brewer 206 in step 1302. However, as there is no patron 208 registered to receive the data, the brew 202a is not active for the brewer 206 and the brewer 206 will not send the data to the brew 202a as shown by incomplete line 1306. In other embodiments, the brewer 206 may forward the data to the brew 202a, but the brew 202a would not send the data anywhere because there is no registered patron 208 for the brewer 206.

In some embodiments, step 1306 may result in an error (e.g., to notify the client 104 and/or the application 602 that there is no destination and the data is not actually being sent) and/or the data may continue to be sent to the module 204a (and ignored by the module 204a ) as the application 602 continues to provide data to send.

In step 1306, a notification of a patron 208 is received by the client 104 from the server 102. For example, another client (not shown) that includes the patron 208 may have been started. The notification may include any needed information for communication with the patron 208 (e.g., address and port information). The patron 208 corresponds to the topic of the brewer 206 and may be a patron at another client (e.g., the patron 208 of the client 106) as shown or may be a patron within the client 104 itself.

In step 1308, the client 104 identifies relevant brewers within the client, including the brewer 206. In step 1310, the client 104 notifies the brewer 206 of the patron 208 (as illustrated by line 616a of FIG. 6), including any needed information for communication with the patron 208 (e.g., address and port information). In step 1312, the brewer 206 activates the brew 202a (as illustrated by line 618a of FIG. 6). This activation informs the brew 202a of the patron 208 and provides any corresponding patron information to the brew 202a, which makes the brew aware that it should start sending data received from the brewer 206 to the patron 208.

It is understood that the brew 202a may already be active with respect to other brewers 206 and/or patrons 208. Accordingly, the concept of “active” for a brew 202 in the present example applies on a per brewer/patron basis, and determines whether the brew 202 will send or receive data for a particular brewer/patron.

In step 1314, the brewer 206 may encrypt the data being sent in embodiments where the brewer 206, rather than the brew 202a, is responsible for data encryption. Accordingly, step 1314 may be omitted if not needed. It is understood that step 1314 may occur prior to activation of the brew 202a (e.g., prior to step 1312).

In step 1316, the brewer 206 begins sending data received from the application 602 (step 1302) to the now active brew 202a. In step 1318, the brew 202a performs any needed processing (e.g., formatting and/or encryption if the brew 202a is configured to encrypt the data) for the data to be sent. In step 1319, the brew 202a sends the data received from the application 602 to the module 204a for transfer to the corresponding module of the other client. It is understood that when the clients 104 and 106 are started relatively simultaneously, step 1304 may be omitted and step 1306 would be the same as step 1014 of FIG. 10, after which step 1302 would occur.

Referring to FIG. 13B, a method 1320 illustrates one embodiment of the process of FIG. 13A. In the present example, steps 1322-1328 are performed by the client 104 and step 1330 is performed by the brewer 206. In step 1322, the client 104 receives a new patron notification. In step 1324, the client 104 looks up all of its registered brewers 206 that correspond to the patron's topic. In step 1326, the client 104 pulls any needed brew information for the brew 202 that is to be used. In step 1328, the client 104 notifies each brewer 206 that there is a new patron 208 and provides any needed information about the patron 208 and/or the brew 202 to each brewer 206. In step 1330, each brewer 206 instructs the brew 202 to start sending its data to the patron 208.

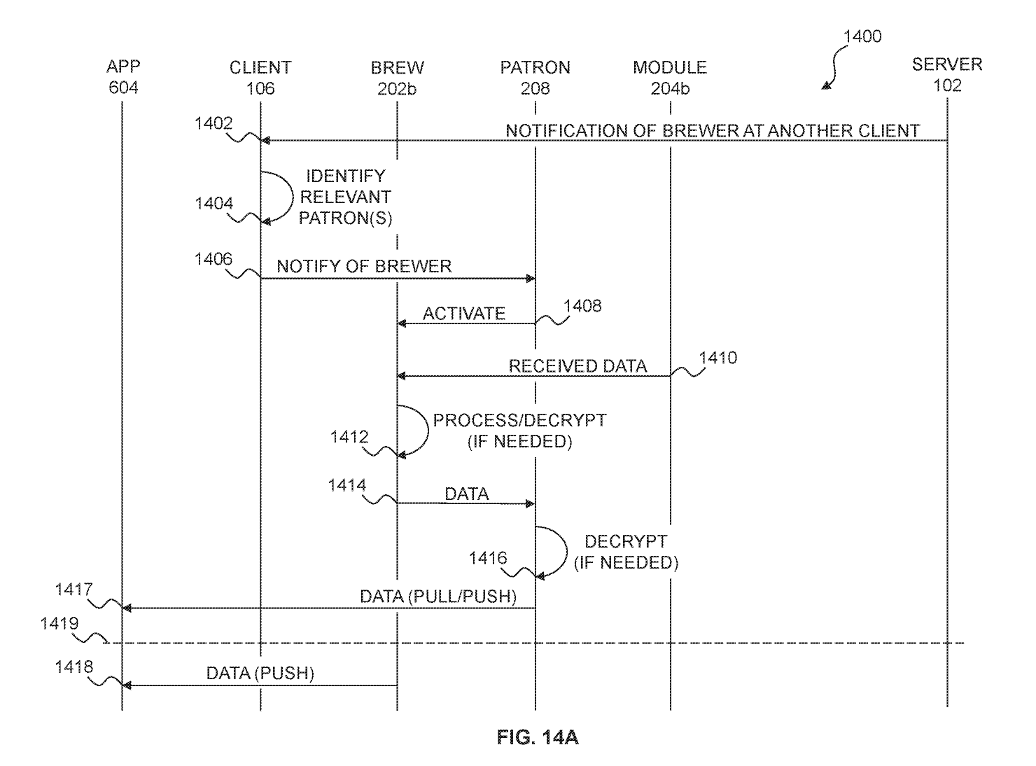

Referring to FIG. 14A, a sequence diagram 1400 illustrates one embodiment of a process by which the client 106 of FIG. 6 may receive and handle data. Prior to step 1402, the client 106 has been started with the patron 208, but either has not received the registration response of step 1012 (FIG. 10) from the server 102 or there is no registered brewer (e.g., the brewer 206 of FIG. 6) corresponding to the patron 208. Accordingly, the patron 208 is not receiving any data.

In step 1402, the client 106 receives a notification from the server 102 about the brewer 206. The notification may include any needed information for communication with the brewer 206 (e.g., address and port information). In step 1404, the client 106 identifies relevant patrons within the client, including the patron 208. In step 1406, the client 106 notifies the patron 208 of the brewer 206 (as illustrated by line 616b of FIG. 6), including any needed information for communication with the brewer 206 (e.g., address and port information).

In step 1408, the patron 208 activates the brew 202b (as illustrated by line 618a of FIG. 6). This activation informs the brew 202b of the brewer 206 and provides any corresponding brewer information to the brew 202b, which makes the brew aware that it should start receiving data from the brewer 206 for the patron 208. At this point, the patron 208 may notify the brew 202b how the incoming data should be handled by defining a callback. For example, the patron 208 may instruct the brew 202b to send the data to the patron 208 (e.g., to be pulled by, or pushed to, the application 604) or to send the data directly to the application 604 (e.g., push the data to the application 604). As with the brew 202a of FIG. 13A, the brew 202a may already be active with respect to other brewers 206 and/or patrons 208. In step 1410, the now active brew 202b receives the data from the module 204b. In step 1412, the brew 202b performs any needed processing (e.g., formatting and/or decryption if the brew 202b is configured to decrypt the data) for the received data. In step 1414, the brew 202b sends the data to the patron 208. In step 1416, the patron 208 may decrypt the data being received in embodiments where the patron 208, rather than the brew 202b, is responsible for data decryption. Accordingly, step 1416 may be omitted if not needed. In step 1417, the patron 208 sends the data to the application 604.

In some embodiments, as illustrated below line 1419, steps 1414, 1416, and 1417 may be replaced by a single step 1418. In step 1418, the brew 202b sends data directly to the application 604. This avoids passing the data through the patron 208.

Referring to FIG. 14B, a method 1420 illustrates one embodiment of the process of FIG. 14A. In the present example, steps 1422-1428 are performed by the client 106 and step 1430 is performed by the patron 208. In step 1422, the client 106 receives a new brewer notification. In step 1424, the client 106 looks up all of its registered patrons 208 that correspond to the brewer's topic. In step 1426, the client 106 pulls any needed brew information for the brew 202 that is to be used. In step 1428, the client 106 notifies each patron 208 that there is a new brewer 206 and provides any needed information about the brewer 206 and/or the brew 202 to each patron 208. In step 1430, each patron 208 instructs the brew 202 to start patronizing (e.g., obtaining data from) the brewer 206.

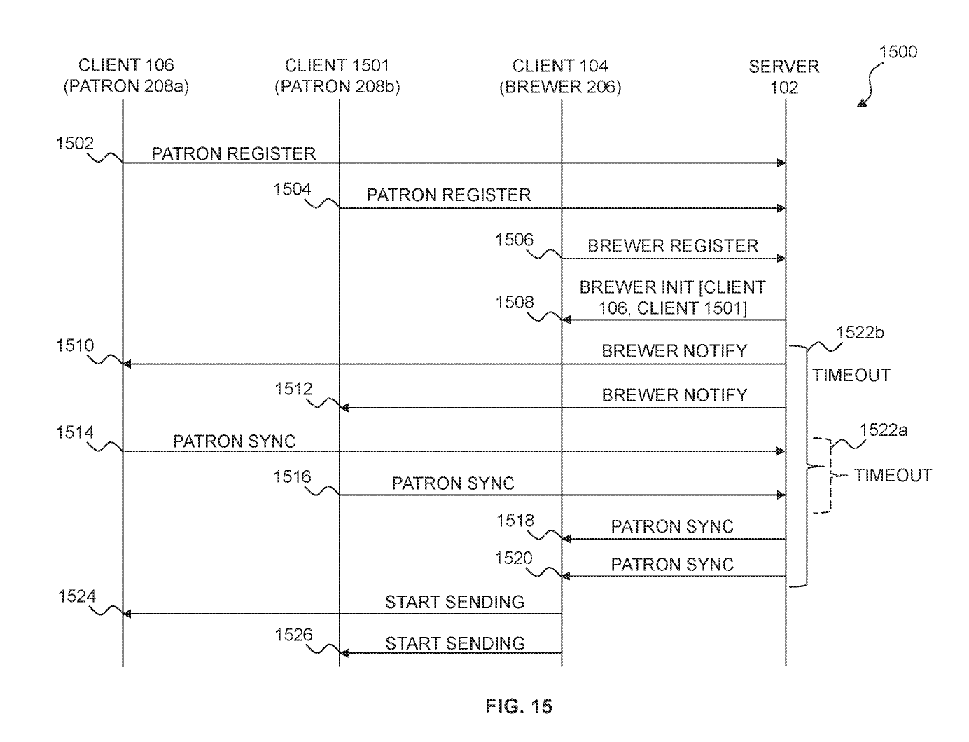

Referring to FIG. 15, a sequence diagram 1500 illustrates one embodiment of a process by which multiple clients within the Pubkeeper system 600 of FIG. 6 may be synchronized. Such synchronization may be desirable in cases where multiple patrons are connecting to a new brewer. The synchronization process is an attempt to have the patrons start by receiving the same data from the brewer, rather than one patron missing data that is received by another patron. In the present example, the internal behavior of the clients 104, 106, and 1501 is not illustrated as previous diagrams (e.g., FIGS. 13A and 14A) have described embodiments of such behavior. Accordingly, client 104 includes brewer 206, client 106 includes patron 208a, and client 1501 includes patron 208b.

As described in previous embodiments, each client 106 and 1501 registers its respective patron with the server 102 in steps 1502 and 1504, and the client 104 registers its brewer 206 with the server in step 1506. In step 1508, the server 102 responds to the client 104 with brewer initialization information that notifies the client 104 of the patron 208a of the client 106 and the patron 208b of the client 1501.

In steps 1510 and 1512, the server 102 notifies the clients 106 and 1501 of the brewer 206. In steps 1514 and 1516, the clients 106 and 1501 acknowledge the notifications with patron synchronization messages that inform the server 102 that the respective patrons 208a and 208b are ready to receive data. In steps 1518 and 1520, the server 102 notifies the client 104 of the patron synchronization messages.

As illustrated by a bracket identified by reference number 1522a, the server 102 may use a timeout period to ensure that any delays will be minimized. For example, the server 102 may wait a predefined period of time (e.g., 500 milliseconds) after sending the brewer notifications in steps 1510 and 1512. If one or both of the patron synchronization messages are not received before the timeout period expires, the server 102 may send one or both of the messages in steps 1518 and 1520 (or a similar message that is not a synchronization message) following the timeout period. It is understood that this may be handled in many different ways. For example, a synchronization message may be sent only for a client from which a patron synchronization message was received.

In other embodiments, the client 104 may use a timeout period in addition to, or as an alternative to, a server based timeout. For example, as illustrated by a bracket identified by reference number 1522b, the client 104 may start a timeout period after receiving the brewer initialization information from the server 102 in step 1508.

Regardless of the method in which the timeout period (if any) is implemented, the brewer 206 will being sending data to the patrons 208a and 208b in steps 1524 and 1526. It is understood that the synchronization process may be omitted entirely in some embodiments, and that data will be sent to the patrons identified in step 1508 without any attempt at synchronization. If a particular patron is not available (e.g., a required connection cannot be established), the brewer 206 may not send data to that patron.

Referring to FIG. 16, one embodiment of the Pubkeeper system 600 of FIG. 6 is illustrated from a data perspective. As shown, the server 102 and the clients 104 and 106 (e.g., the system functionality 210 of FIG. 2) are not involved in the actual transfer of data from the application 602 to the application 604.

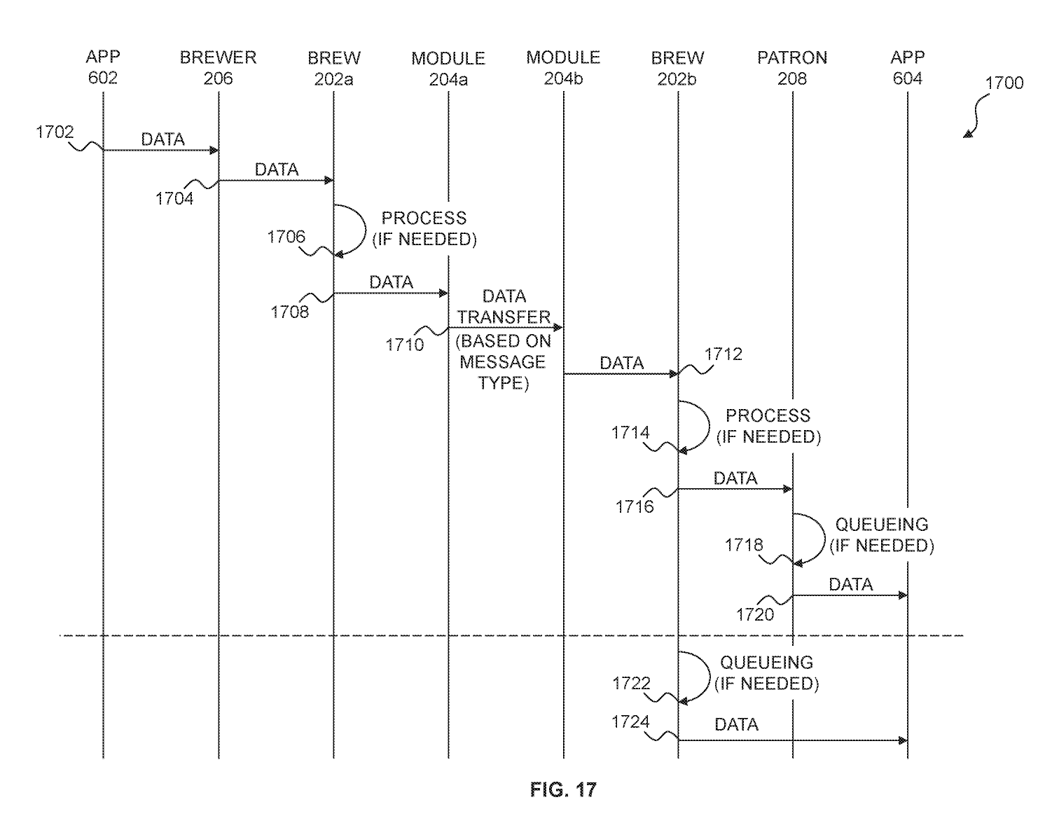

With additional reference to FIG. 17, a sequence diagram 1700 illustrates one embodiment of a process by which data flow may occur within the Pubkeeper system 600 of FIG. 17. The data is to be sent from the application 602 to the application 604.

In step 1702, the data for Topic 1 is sent from the application 602 to the brewer 206 as the brewer 206 corresponds to Topic 1. In step 1704, the brewer 206 sends the data to the brew 202a, which identifies the brewer's ID as corresponding to Topic 1. In step 1706, the brew 202a performs any needed processing (e.g., formatting of the data for the module 204a and/or encryption). The brew 202a then sends the data to the module 204a in step 1708.

In the present example, the brews 202a and 202b are responsible for encryption and decryption, respectively. In embodiments where the brewer 206 is responsible for encryption and the patron 208 is responsible for decryption, the sequence diagram 1700 may be modified as illustrated in FIGS. 13A and 14A to account for such encryption and decryption.

In step 1710, the module 204a transfers the data to the module 204b. The transfer process may vary based on the particular transfer mechanism used by the message type represented by the modules 204a and 204b. The module 204b sends the received data to the brew 202b in step 1712. In step 1714, the brew 202b performs any needed processing (e.g., formatting of the data and/or decryption). The brew 202a then sends the data to the patron 208 in step 1716. In step 1718, the patron 208 queues the data (if needed) before sending the data to the application 604 in step 1720. In some embodiments, the brews 202a and/or 202b may be capable of queueing. Steps 1716-1720 are represented in FIG. 16 by lines 1602a and 1602b, respectively, which show the data passing through the patron 208.

In another embodiment, steps 1716-1720 may be replaced by a callback that bypasses the patron 208. In this embodiment, the brew 202b may perform any needed queuing in step 1722 before sending the data directly to the application 604 in step 1724. In other embodiments of the callback process, the brew 202b may not be capable of queueing and received data may be streamed directly to the application 604 or written to a storage area for later retrieval by the application 604. Step 1724 is represented in FIG. 16 by line 1604, which shows the data bypassing the patron 208.

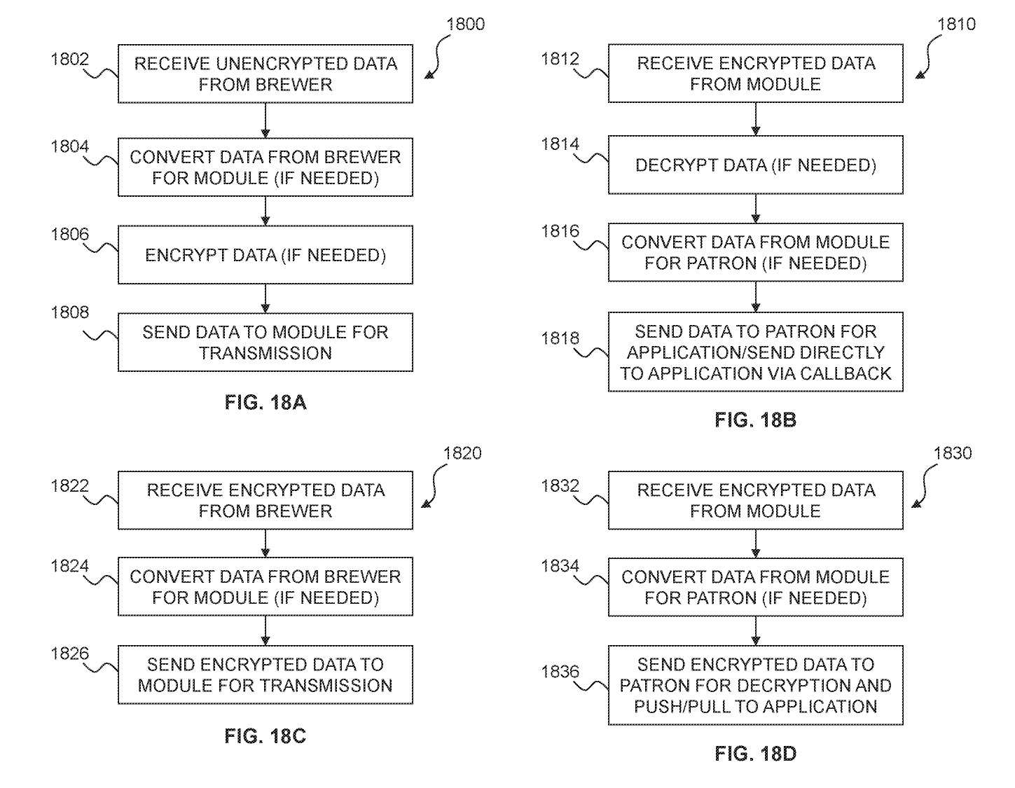

Referring to FIG. 18A, a method 1800 illustrates one embodiment of a process of that may be executed by the brew 202a of FIG. 17 when the brew 202a is responsible for encryption. In step 1802, unencrypted data is received from the brewer 206. In step 1804, the data is converted as needed for the module 1804. This step prepares the data for sending by the module 204a and may vary based on the requirements of the module 204a (e.g., formatting and/or segmentation of the data). In step 1806, the data may be encrypted if needed (e.g., if encryption is required or desired). In step 1808, the data is sent to the module 204a for transmission.

Referring to FIG. 18B, a method 1810 illustrates one embodiment of a process of that may be executed by the brew 202b of FIG. 17 when the brew 202b is responsible for decryption. In step 1812, encrypted data is received from the module 204b. In step 1814, the data is decrypted if needed. In step 1816, the data is converted for the patron 208 if needed. In step 1816, the data may be sent to the patron 208 or directly to the application 604.

Referring to FIG. 18C, a method 1820 illustrates one embodiment of a process of that may be executed by the brew 202a of FIG. 17 when the brew 202a is not responsible for encryption. In step 1822, encrypted data is received from the brewer 206. In step 1824, the data is converted as needed for the module 1804. This step prepares the data for sending by the module 204a and may vary based on the requirements of the module 204a (e.g., formatting and/or segmentation of the data). In step 1826, the still encrypted data is sent to the module 204a for transmission.

Referring to FIG. 18D, a method 1830 illustrates one embodiment of a process of that may be executed by the brew 202b of FIG. 17 when the brew 202b is not responsible for decryption. In step 1832, encrypted data is received from the module 204b. In step 1834, the data is converted for the patron 208 if needed. In step 1836, the still encrypted data may be sent to the patron 208 for decryption and relay to the application 604.

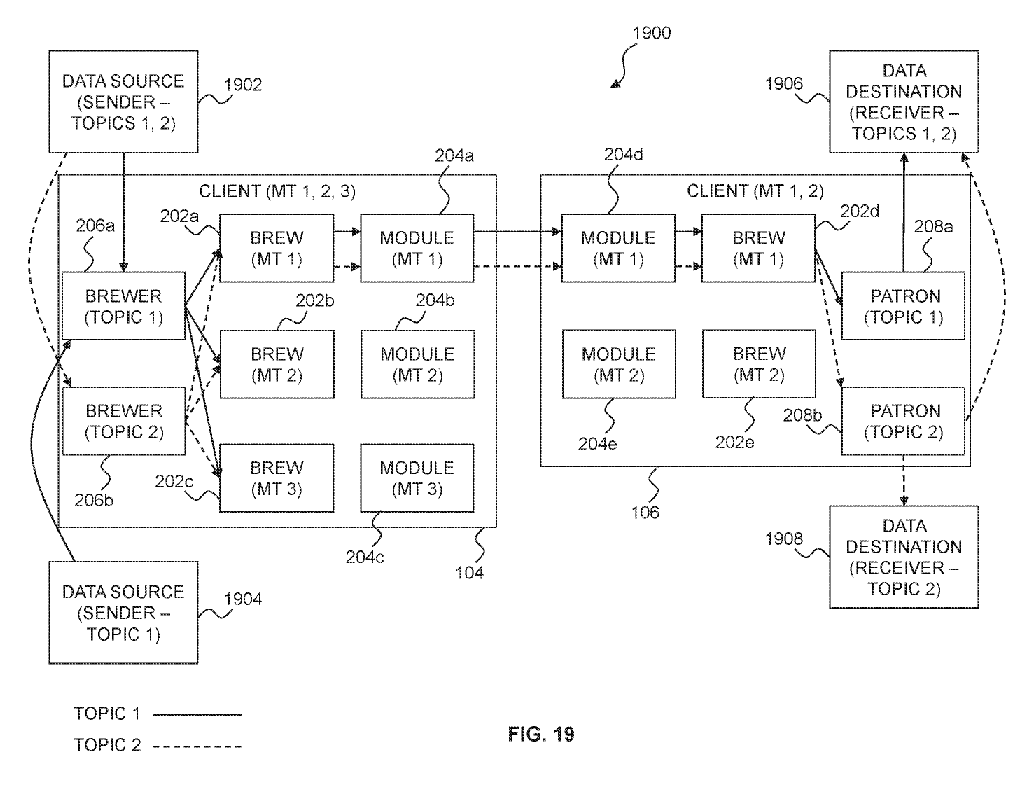

Referring to FIG. 19, a diagram illustrates one embodiment of a system 1900. The system 1900 includes a data source 1902 (Topics 1 and 2), a data source 1904 (Topic 1), a data destination 1906 (Topics 1 and 2), and a data destination 1908 (Topic 2). The data sources 1902 and 1904, and the data destinations 1906 and 1908, may be different parts of a single application or may be different applications.

The system 1900 further includes a client 104 and a client 106. The client 104 is configured for message types 1, 2, and 3, and includes a brewer 206a for Topic 1 and a brewer 206b for Topic 2. The client 104 further includes a brew 202a and a corresponding module 204a (MT 1), a brew 202b and a corresponding module 204b (MT 2), and a brew 202c and a corresponding module 204c (MT 3). The client 106 is configured for message types 1 and 2, and includes a patron 208a for Topic 1 and a patron 208b for Topic 2. The client 106 further includes a brew 202d and a corresponding module 204d (MT 1) and a brew 202e and a corresponding module 204e (MT 2).

As illustrated, the data source 1902 sends its Topic 1 data to the brewer 206a and its Topic 2 data to the brewer 206b. The data source 1904 sends its Topic 1 data to the brewer 206a. Each brewer 206a and 206b sends the data to all of the available brews 202a, 202b, and 202c, which can distinguish the data by brewer ID. By sending its data to all available brews 202a-202c, a brewer 206 does not need to know which brew is being used for the actual transfer. In other embodiments, a brewer 206 may be configured with information as to which brew 202 will be used for transmission, and the brewer may send its data only to that brew.

A pubkeeper server 102 (not shown) has determined that the clients 104 and 106 should communicate using MT 1. Accordingly, the data for both Topic 1 and Topic 2 is sent out by the brew 202a via the module 204a. Although the brews 202b and 202c receive the data, they are not active in this example and do not send the data to their corresponding modules 208b and 208c.

The module 204d receives the data for Topic 1 and Topic 2 and sends the data to the brew 202d. The module 204e and the brew 202e are inactive in this transaction. The brew 202d sends the Topic 1 data to the patron 208a and the Topic 2 data to the patron 208b. The patron 208a sends the Topic 1 data to the data destination 1906. The patron 208b sends the Topic 2 data to the data destinations 1906 and 1908.

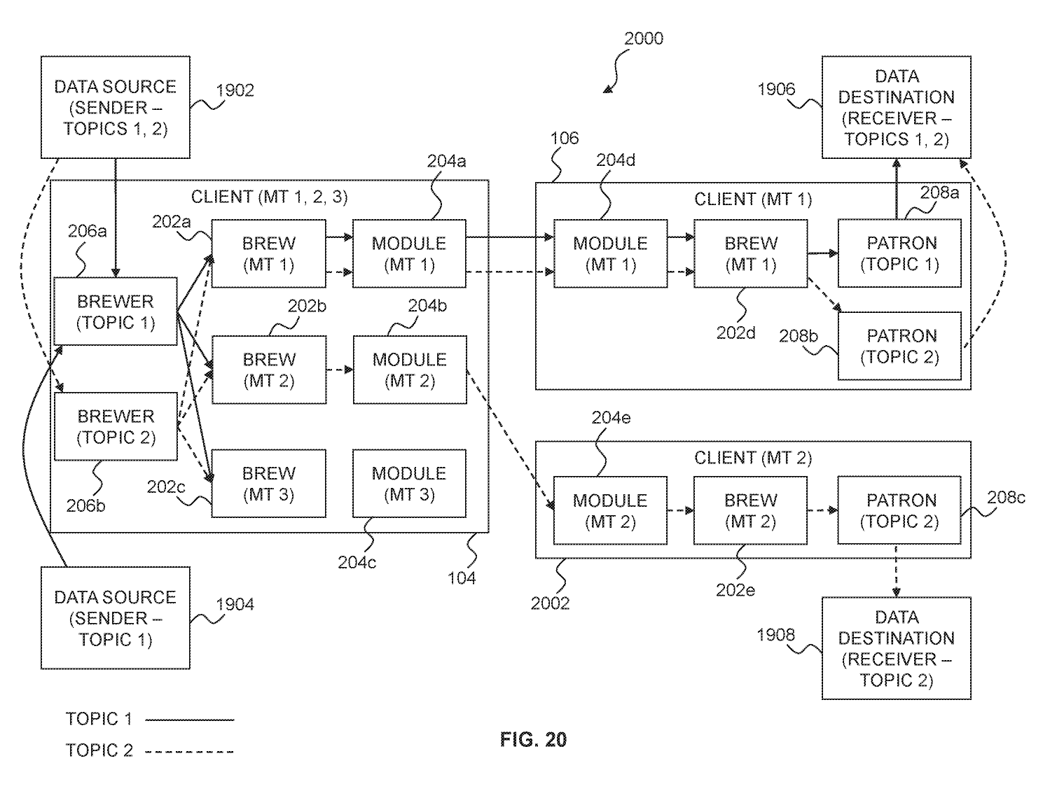

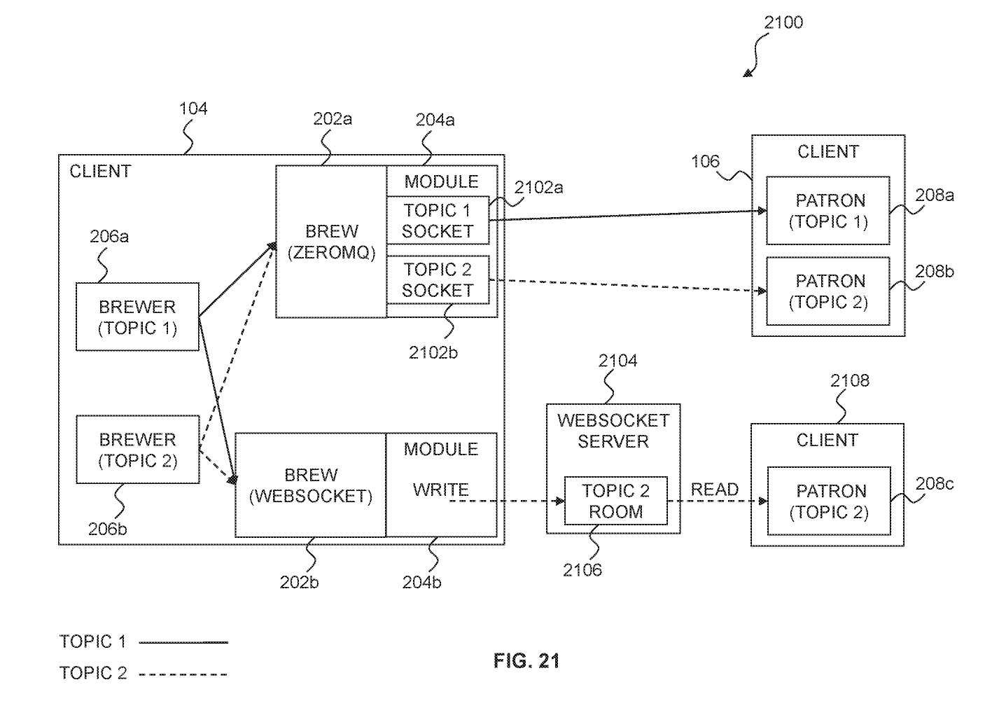

Referring to FIG. 20, a diagram illustrates one embodiment of a system 2000 that is a variation of the system 1900 of FIG. 19. In the present example, the client 106 is associated with the data destination 1906 and a client 2002 is associated with the data destination 1908. The client 104 communicates with the client 106 using MT 1 and the client 2002 using MT 2. Unused modules and brews have been omitted from the clients 106 and 2002 for purposes of clarity.

As illustrated, the data source 1902 sends its Topic 1 data to the brewer 206a and its Topic 2 data to the brewer 206b. The data source 1904 sends its Topic 1 data to the brewer 206a. Each brewer 206a and 206b sends the data to all of the available brews 202a, 202b, and 202c. The brews 202a (MT 1) and 202b (MT 2) are the active brews. The data for both Topic 1 and Topic 2 is sent out by the brew 202a via the module 204a to the module 204d. The data for Topic 2 is sent out by the brew 202b via the module 204b to the module 204e. In the present example, the MT 1 and MT 2 modules are configured with different sockets or channels for different topics, and so only the data for Topic 2 (but not the data for Topic 1) is sent to the module 204e.

The module 204d receives the data for Topic 1 and Topic 2 and sends the data to the brew 202d. The brew 202d sends the Topic 1 data to the patron 208a and the Topic 2 data to the patron 208b. The patron 208a sends the Topic 1 data to the data destination 1906. The patron 208b sends the Topic 2 data to the data destination 1906.

The module 204e receives the data for Topic 2 and sends the data to the brew 202e. The brew 202e sends the Topic 2 data to the patron 208c. The patron 208c sends the Topic 2 data to the data destination 1908.

Referring to FIG. 21, a diagram illustrates one embodiment of a system 2100 (e.g., the system 2000 of FIG. 20) in which a client 104 is to transfer data to clients 106 and 2108. The client 104 includes a ZeroMQ brew 202a and a Web Socket brew 202b. It is understood that these are for purposes of example and may be any message type. The client 104 also includes a brewer 206a for Topic 1 and a brewer 206b for Topic 2. Data sources have been omitted for the client 104 in the present example, but would interact with the illustrated components as previously described.

The client 106 includes a patron 208a for Topic 1 and a patron 208b for Topic 2. The client 2108 includes a patron 208c for Topic 2. Data destinations and brews 202 have been omitted from the clients 106 and 2108 in the present example, but would interact with the illustrated components as previously described.

The clients 104 and 106 communicate via ZeroMQ and the clients 104 and 2108 communicate via WebSockets. The brewers 206a and 206b send their data to both of the brews 202a and 202b.

Because the behavior of a brew 202 depends on the characteristics and requirements of the underlying module, each brew operates as needed for its module. For example, a ZeroMQ brew may use a separate socket on the corresponding module for each topic. This allows the brew to send/receive data for each topic via the corresponding socket. A Web Socket brew may be coupled to one or more WebSocket servers, and may use a different room for each topic. This means that “sending” involves writing to the appropriate room and “receiving” means reading from the appropriate room.

Because of differences between the brews 202a and 202b, the timing of various actions such as resource allocation may differ. For example, with respect to the brew 202a, the sockets 2102a and 2102b are created by the module 204a when the corresponding brewers 206a and 206b are created. This is specific to the ZeroMQ implementation of the brew 202a. In contrast, when the brew 202b is created, the module 204b creates the user resources. This is specific to the Web Sockets implementation of the brew 202b.

Accordingly, as illustrated in FIG. 21, the module 204a includes a socket 2102a for Topic 1 and a socket 2102b for Topic 2. More specifically, when each of the brewers 206a and 206b are created, a socket for their corresponding topic is created (or associated if already existing) in the ZeroMQ module 204a with the brewer's ID. The brew 202a can then link the brewers 206a and 206b with their corresponding sockets 2102a and 2102b, respectively, which enables the brew 202a to correctly route the data received from each brewer 206a and 206b.

The patron 208a is aware of the socket 2102a and is able to receive data from the socket 2102a via a ZeroMQ module and brew (not shown) of the client 106. The patron 208b is aware of the socket 2102b and is able to receive data from the socket 2102b via the ZeroMQ module and brew of the client 106.

In the present example, the WebSocket brew 202b writes to a room 2106 for Topic 2 on a Web Socket server 2104. The patron 208c is aware of the room 2106 and is able to read data from the room 2106 via a Web Socket module and brew (not shown) of the client 2108.

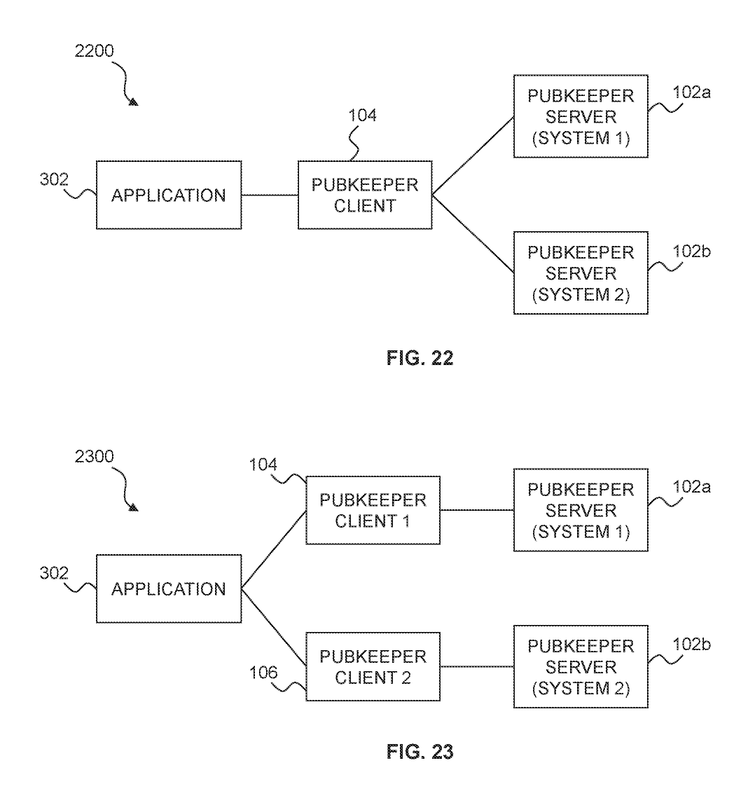

Referring to FIG. 22, one embodiment of a system 2200 includes a Pubkeeper server 102a that is part of one Pubkeeper system (System 1) and a Pubkeeper server 102b that is part of a different Pubkeeper system (System 2). As shown the Pubkeeper client 104 communicates with both of the Pubkeeper servers 102a and 102b, which means that the application 302 only needs the single client to participate in both Pubkeeper systems.

Referring to FIG. 23, one embodiment of a system 2300 includes a Pubkeeper server 102a that is part of one Pubkeeper system (System 1) and a Pubkeeper server 102b that is part of a different Pubkeeper system (System 2). In the present example, the application 302 uses two separate clients 104 and 106. The client 104 communicates with the server 102a and the client 106 communicates with the server 102b.

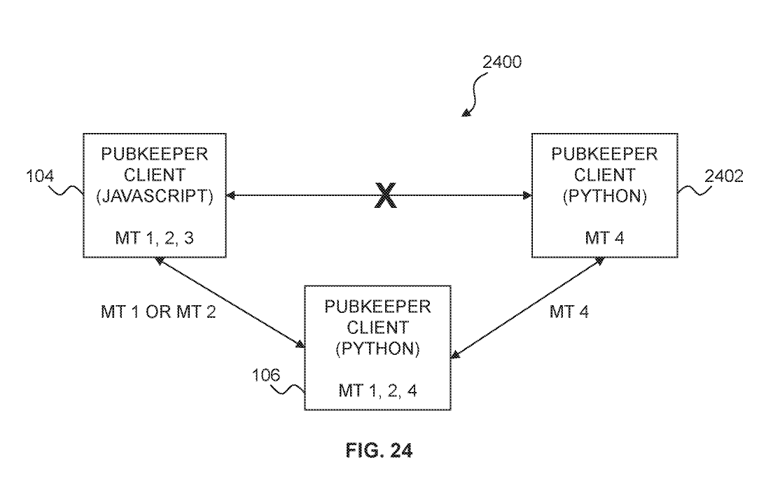

Referring to FIG. 24, one embodiment of a system 2400 includes a client 104, a client 106, and a client 2402. As illustrated, the client 104 may communicate using message types 1, 2, and 3. The client 106 can communicate using message types 1, 2, and 4. The client 2402 can only communicate using message type 4. This means that the clients 104 and 2402 cannot communicate directly. Accordingly, the client 106, which can communicate with both the client 104 and the client 2402, may relay communications between the two endpoints 104 and 2402. For example, the client 106 may receive a message from one client, convert the message into the appropriate message type, and send the message to the other client. This allows the clients 104 and 2402 to participate fully in the Pubkeeper system and with each other without requiring additional message types to be added to the client 104 and/or the client 2402 for such communications.

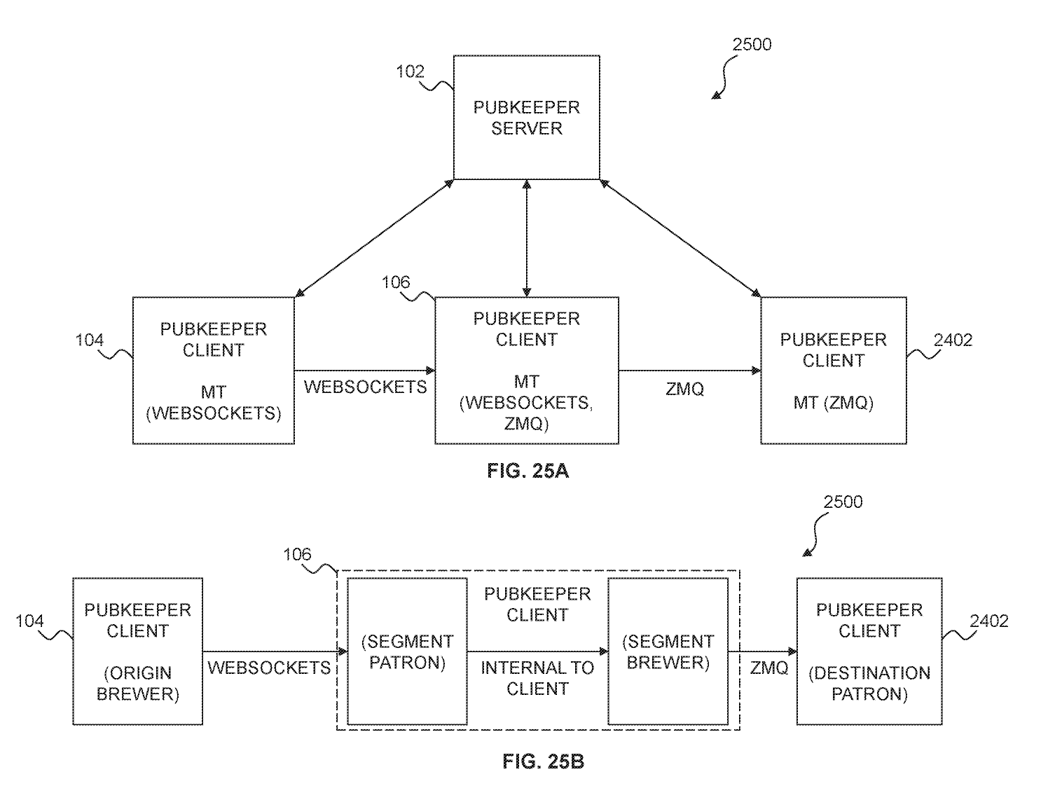

Referring to FIGS. 25A and 25B, a system 2500 illustrates a more detailed embodiment of the system 2400 of FIG. 24. The system 2500 enables the client 104 to communicate with the client 2502 via a bridge provided by the client 106. For purposes of example, the client 104 includes a brewer that publishes using WebSockets, the client 2402 includes a patron that uses ZeroMQ and wants to receive information output by the brewer of the client 104, and the client 106 can communicate using both WebSockets and ZeroMQ. The client 104 is not configured to use ZeroMQ, the client 2402 is not configured to use WebSockets, there are no compatible message types available between the clients 104 and 2402, and the client 106 will be used to bridge the WebSocket/ZeroMQ gap. It is understood that these may be any message types and that Web Sockets and ZeroMQ are used only as examples.

The bridge client 106 represents a bridge segment that connects the client 104 to the client 2402. The bridge segment is formed by a brewer and patron pair of the client 106, with the bridge segment patron connecting to the brewer of the client 104 and the bridge segment brewer publishing to the patron of the client 2402. While the data path illustrates data flowing from the client 104 to the client 2402, it is understood that communications may flow from the client 2402 to the client 104 in embodiments where the client 104 has a patron for a topic published by a brewer on the client 2402 and/or if needed for call setup or maintenance (e.g., for signaling). As will be shown in a later embodiment, there may be multiple bridge clients between the clients 104 and 2502 if needed to provide the necessary message types for the client 104 and 2402 to communicate.

A Pubkeeper server 102 (FIG. 25A) is responsible for identifying the appropriate bridge client(s) and setting up the bridge segments needed to support the two clients 104 and 2402 that are trying to communicate. To facilitate this process, the server 102 may keep a list of orphans for the system 2500. Each orphan represents a brewer or patron, along with the corresponding topic and message type, that does not have a matching patron or brewer, respectively. For example, the client 104 may have a brewer that publishes to a topic “sensor data” using WebSockets and the client 2402 may have a patron that uses only ZeroMQ but wants to subscribe to that topic. If there is no available bridge to connect the brewer to the patron, the server 102 will add the brewer and patron to the orphan list. When a new client comes online, the server 102 will check to see if the new client can provide a bridge for any of the orphans. If a desired bridge is made available by the new client, the server 102 will facilitate the bridging process and remove the corresponding orphans from the list. An orphan may remain on the list until a bridge is established, the client leaves the system 2500, or the client closes the brewer or patron.

Depending on the particular implementation of bridge mode within the system 2500, bridge mode may be optional for a particular client (e.g., opt-in or opt-out) or may be mandatory. If optional, bridge mode may be disabled by default and enabled only if a client registers with the server 102 to enable bridge mode. Bridge mode may be enabled by a client only for particular brews or for all brews that are supported by the client.

By providing control over bridge mode on a per client basis, clients that may be negatively impacted by bridging (e.g., clients with little or no extra processing power and/or the network capacity needed to handle bridge mode in addition to their assigned tasks) can be configured to refrain from bridging while clients that will not be negatively impacted can be used in bridge mode. As there will likely be additional resources available for bridging within the Pubkeeper system 2500, a system may usually be planned normally and operate effectively without explicitly planning for each client to have the resources needed for bridge mode.

In the present embodiment, a client may be both a bridge client and a regular subscriber and/or publisher (e.g., may be configured to produce and/or consume information as part of the client's non-bridge mode operation) within the system 2500. However, in other embodiments, clients that are regular subscribers and/or publishers may not be allowed to serve as bridge clients for security reasons. In such embodiments, a bridge client will exist only to handle bridging. In the present embodiment, the server 102 will not create a bridge node because the server 102 is not to be involved in the transmission of information for security reasons. However, in other embodiments, if no bridge is available, the server 102 may launch a client to serve as a bridge or may instruct another device to create a bridge client, or may override a client that has indicated that it does not want to be a bridge client and force the client into bridge mode.

As shown in FIG. 25B, communications within the bridge client 106 (e.g., between the segment patron and segment brewer) are internal to the client 106. For example, when creating the segment, the segment brewer may be created first and then the segment patron may be created with a callback to the segment brewer. This enables the segment patron to pass received data directly to the segment brewer within the client 106 and the data is not made available outside of the client 106. More specifically, the segment patron receives the raw data from its assigned brew and passes the raw data to the segment brewer, which in turn sends the raw data out through its assigned brew.

Because decryption/encryption occur at the patron/brewer level in the present embodiment (rather than at the brew level as described in some previous embodiments), the segment patron and segment brewer are created with instructions to not decrypt or encrypt the raw data. This maintains the raw data in its original state, which means that the original encryption and decryption keys used by the origin brewer and destination patron remain valid. In addition, this prevents the data from being decrypted by a segment (which does not have the decryption key), thereby increasing the security of the transmitted data.

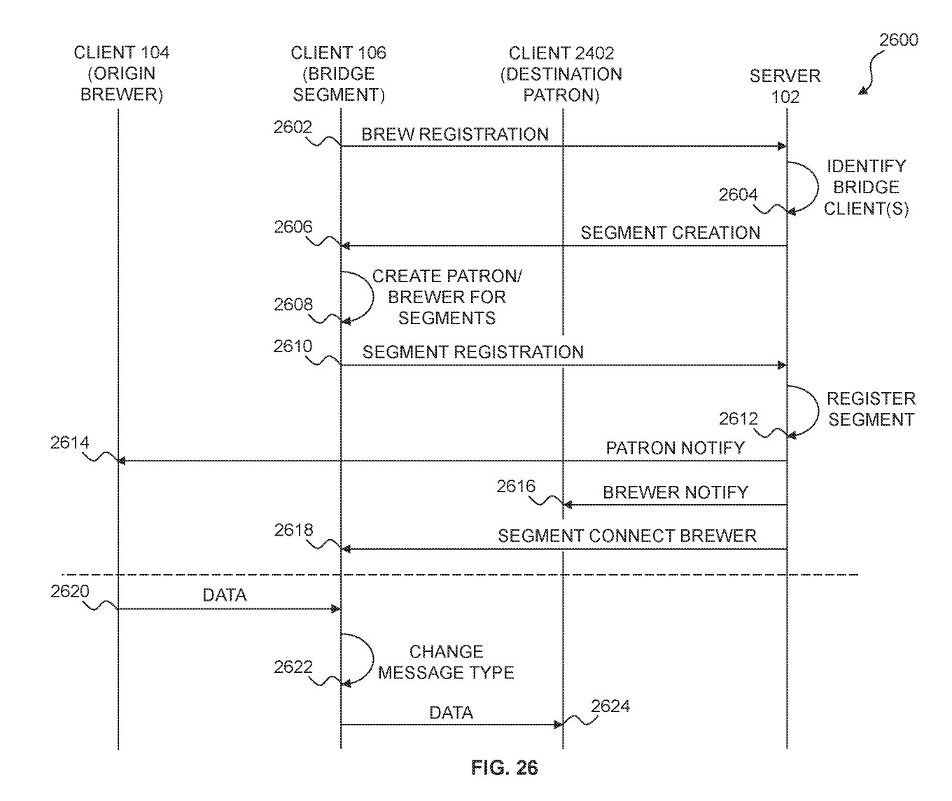

Referring to FIG. 26, a sequence diagram 2600 illustrates one embodiment of a process by which the client 106 of FIGS. 25A and 25B may become a bridge between the clients 104 and 2402 within the Pubkeeper system 2500. The internal behavior of the clients 104, 106, and 2402 is not illustrated as previous diagrams have described embodiments of such behavior. In addition, initial registration by the clients 104, 106, and 2402 with the server 102 has been omitted for purposes of clarity other than a brew registration message by the client 106.

In the present example, due to the way in which the bridge is established, the client 104 and the client 2402 are unaware of the bridge client 106. Accordingly, the brewer of the client 104 assumes that it is publishing directly to the destination that wants the data being published (e.g., the patron of the client 2402). Similarly, the patron of the client 2402 assumes that it is subscribed directly to the origin of the data being received (e.g., the brewer of the client 104). In other embodiments, one or both of the clients 104 and 2402 may be aware that the bridge client 106 is serving as an intermediary.

In step 2602, the client 106 sends a brew registration message to the server 102. The brew registration message may be part of a regular registration message (e.g., the message of step 718 of FIG. 7) or may be a separate message. An example of a brew registration message for the client 106 is shown below.

```
  {
    brews: [
          ‘websocket’,
          ‘zmq’
    ],
    bridge_mode: True
}
```

The illustrated brew registration message informs the server 102 of all the brews that the client 106 will be using and whether the client 106 is available as a bridge. In the present example, “bridge_mode: True” indicates that the client 106 is available as a bridge for the listed brews, while “bridge_mode: False” would indicate that the client 106 is not available as a bridge.

In some embodiments, the “true” or “false” indicator may be at least partly based on a status of each brew. For example, if a particular brew is unavailable and it is one of only two brews on that client 106, then there can be no bridging. While the bridge mode status may still be set to true in this case, bridging would only occur if the client later notified the server of a second active brew. If there are three or more brews and at least two of those brews are functional, then the client 106 may be used as a bridge as long as the functional brews are the brews needed for bridging.

In some embodiments, the server 102 may be notified of the status of each brew at the time of registration, a later status message may be sent, or the server 102 may be notified of a non-functional brew only when the server 102 attempts to create a bridge using the brew. Accordingly, brew status may be used to indicate whether a particular brew is currently available. For example, ZeroMQ may have a status of “OK” or “ERROR.”

In step 2604, the server 102 identifies the client(s) to be used for bridge mode with the clients 104 and 2402, which includes the client 106 in the present example. If multiple bridge possibilities are available, the server 102 may use the first available client, may calculate shortest/fastest path for bridge selection, may use the client(s) with the most available resources, and/or may choose the bridge client(s) in other ways.

In step 2606, the server 102 sends a segment creation message to the client 106. In the present example, the segment creation message instructs the client 106 to create a WebSocket patron and a ZeroMQ brewer that will be needed for the clients 104 and 2402, respectively. An example of a segment creation message is as follows:

```
      {
        ‘patron_details’: {
            ‘patron_id’: ‘a1e88daacf58495a84000ce4ab166725’,
            ‘prev_brewer_id’: ‘19beb2a0e4094af1921ac3c17a3608de’
            ‘brew’: {‘sock’: ‘/tmp/
19beb2a0e4094af1921ac3c17a3608de.sock’, ‘name’: ‘local-
83779604500539’},
            ‘topic’: ‘example.topic’,
        },
        ‘brewer_details’: {
            ‘brewer_id’: ‘50176f68a6cf4fc38dfbb0e4e2c3f2c1’
            ‘brew_name’: ‘zmq’,
            ‘topic’: ‘example.topic’,
        },
        ‘segment_id’: ‘f9d43d33926147d9ac8be5dc0b0fc78e’,
}
```

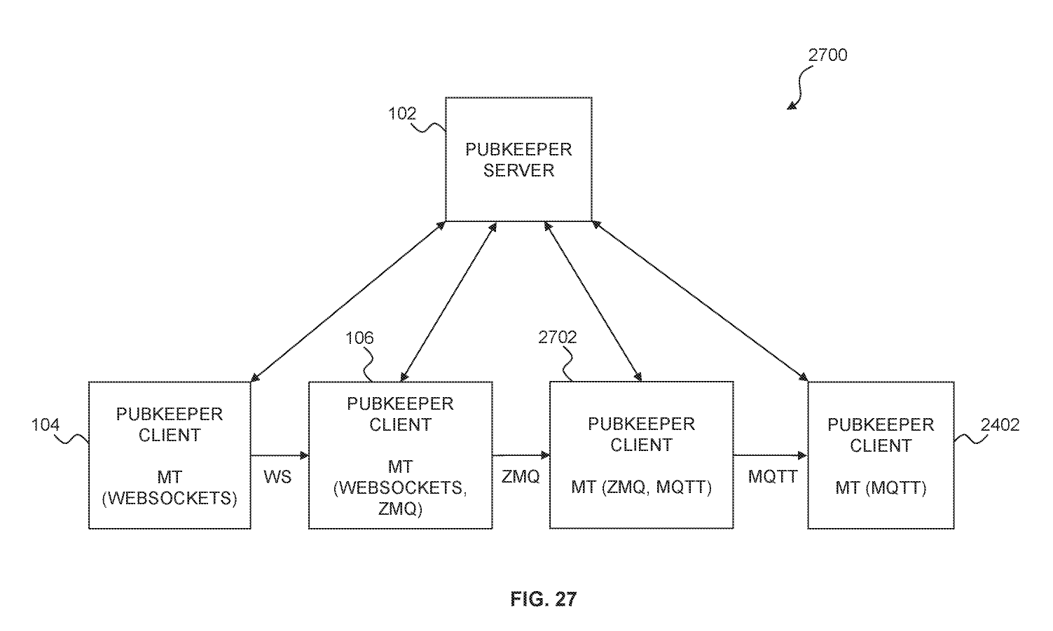

As shown, the segment creation message includes patron details for the bridge's patron, brewer details for the bridge's brewer, and a unique segment identifier. The patron details include a patron identifier that is assigned by the server 102, the brewer from which the patron will receive information (prev_brewer_id), the brew that is used by the previous brewer and any relevant information so that the patron can subscribe to that brewer, and the topic (e.g., example_topic). The previous brewer may be the originating brewer (e.g., the brewer of the client 104) or the brewer of the previous bridge in a chain of bridge clients (e.g., as shown in FIG. 27).

The brewer details include a brewer identifier that is assigned by the server 102, the name of the brew that the brewer is to use, and the topic. The topic name used by the brewer of the last bridge in a chain of bridges or a single bridge if only one bridge is used may be assigned using one of two different naming conventions. The first naming convention assigns the bridge's brewer topic the same name as that of the origination topic (e.g., the topic name used by the originating brewer of the client 104). This allows the patron of the final destination client (e.g., the client 2402) to subscribe to the topic using the original name. The second naming convention assigns the bridge's brewer topic a new name that does not match the originating brewer's topic, such as a randomized or otherwise selected name, and requires the final patron to subscribe to the assigned name. For example, rather than using the name “example.topic,” the name may be assigned as “709d9eb2361842deae963f01c0365ea6.”

The first naming convention enables the bridging process to occur without the final patron's knowledge. In other words, the patron of the client 2402 is subscribing to the same topic as that of the brewer of the client 104. A potential downside is that in some embodiments, such as when a WebSocket server is being used, the bridge's brewer may be publishing into a room that may have multiple subscribers, some of which are subscribed directly to the originating brewer rather than the bridge's brewer. While the data being written to the room by the bridge's brewer is the same data that would be written to the room by the originating client's brewer, it is possible that complications might occur. For example, this process can technically nullify the WebSocket room's last value caching (if enabled), since the last value may be written by the bridge's brewer rather than the originating client's brewer.

The second naming convention provides a unique subscription channel for the final patron, but means that the final patron will be subscribing to the bridge brewer's topic name rather than the originating brewer's topic name. This exposes the destination client's patron to the bridging process because the destination client's patron is subscribing to a different topic name. This may complicate the process on the destination client's end, while solving the potential problems of the first naming convention. In the present example, the first naming convention is used.

In multi-bridge scenarios, topic names between bridges may be different from the originating brewer's topic name, but will generally be consistent between all the bridges. For example, the name “709d9eb2361842deae963f01c0365ea6” may be used between bridges even if the first naming convention is implemented and the final bridge's brewer uses the original topic name.

The unique segment identifier enables the server 102 to distinguish between different segments and enables the client 106 to support multiple simultaneous segments for different bridges, with each segment having a unique segment identifier. The use of uniquely identifiable segments enables the server 102 to instruct the client 106 to terminate or modify specific segments based on their identifiers.

In step 2608, the client 106 creates the segment patron needed to receive information from the client 104 and the segment brewer needed to publish information for the client 2402. In step 2610, the brewer and patron on the client 106 are registered with the server 102 for the segment identifier provided in the segment creation message of step 2606. The segment registration of step 2610 may serve as a response to the segment creation message. An example of a segment registration message for the client 106 is as follows:

```
  {
    ‘brewer_brew’: {
          ‘publisher_url’: ‘tcp://127.0.0.1:9097’,
          ‘name’: ‘zmq’
    },
    ‘patron_brew’: {
          ‘name’: ‘local-83779604500539’
    },
    ‘segment_id’: ‘f9d43d33926147d9ac8be5dc0b0fc78e’
}
```

The segment registration message notifies the server 102 of the bridge's brewer and patron information, and identifies the bridge by its segment identifier. In step 2612, the server 102 registers the information received from the client 106 in step 2610.

In step 2614, the server 102 sends a patron notify message to the client 104 to inform the client 104 of the segment patron of the client 106. This message is similar or identical to the patron notification of step 1306 of FIG. 13A.

In step 2616, the server 102 sends a brewer notify message to the client 2402 to inform the client 2402 of the brewer of the client 106. This message is similar or identical to the brewer notification of step 1402 of FIG. 14A.

In step 2618, the server 102 sends a segment connect brewer message to the client 106. The segment connect brewer message serves as a patron notification to the client 106, providing the brewer of the client 106 with the patron information of the next client (e.g., the client 2402) in a manner similar to that of the patron notify of step 2614. While the server 102 already knows the patron information needed by the brewer of the client 106 in the present example, the information is not sent until this time for consistency with multi-bridge embodiments where such information may not be known until each bridge segment is created. It is understood that the patron notify of step 2614, the brewer notify of step 2616, and the segment connect brewer message of step 2818 may be sent in a different order or simultaneously.

It is noted that there may not be an explicit brewer notification for the segment patron of the bridge client 106, as the brewer notification may be an implicit part of the earlier segment creation message for that bridge client when the patron is created. In other words, by creating the patron and brewer on the bridge client 106 for the bridge segment, the patron is automatically aware of the existence of the corresponding brewer, which negates the need for an explicit brewer notify message for the patron.

Following step 2618, the bridge segment is complete and data from the client 104 can be communicated to the client 2402 via a first leg from the origin brewer of the client 104 to the segment patron of the client 106, between the segment patron and the segment brewer of the client 106, and then via a second leg from the segment brewer of the client 106 to the destination patron of the client 2402. To accomplish this, data corresponding to the desired topic that is published by the client 104 is received by the client 106 in step 2620. In the present example, the data is received via WebSocket and is to be sent to the client 2402 via ZeroMQ. Accordingly, in step 2622, the client 106 prepares the data for ZeroMQ transmission. It is understood that the data itself is generally not altered. For example, the data may be extracted from the payload of the incoming messages and inserted into the payload of outgoing messages and sent. This enables encrypted data to be received and relayed without alteration. In other embodiments, data may be altered if desired. In step 2624, the data is sent to the client 2402.

Referring to FIG. 27, a system 2700 illustrates an embodiment of the system 2500 of FIGS. 25A and 25B with a second bridge client 2702. In the present example, the client 104 publishes information via WebSockets and the client 2402 wants to receive the published information but only uses MQTT. The system 2700 does not include an available bridge client that uses both WebSockets and MQTT. However, the system 2700 includes the client 106 that uses WebSockets and ZeroMQ, and a client 2702 that uses ZeroMQ and MQTT. Accordingly, the client 106 can provide a Web Socket to ZeroMQ bridge segment and the client 2702 can provide a ZeroMQ to MQTT bridge segment to enable the client 2402 to receive the information published by the client 104. It is understood that these may be any message types and that WebSockets, ZeroMQ, and MQTT are used only as examples.

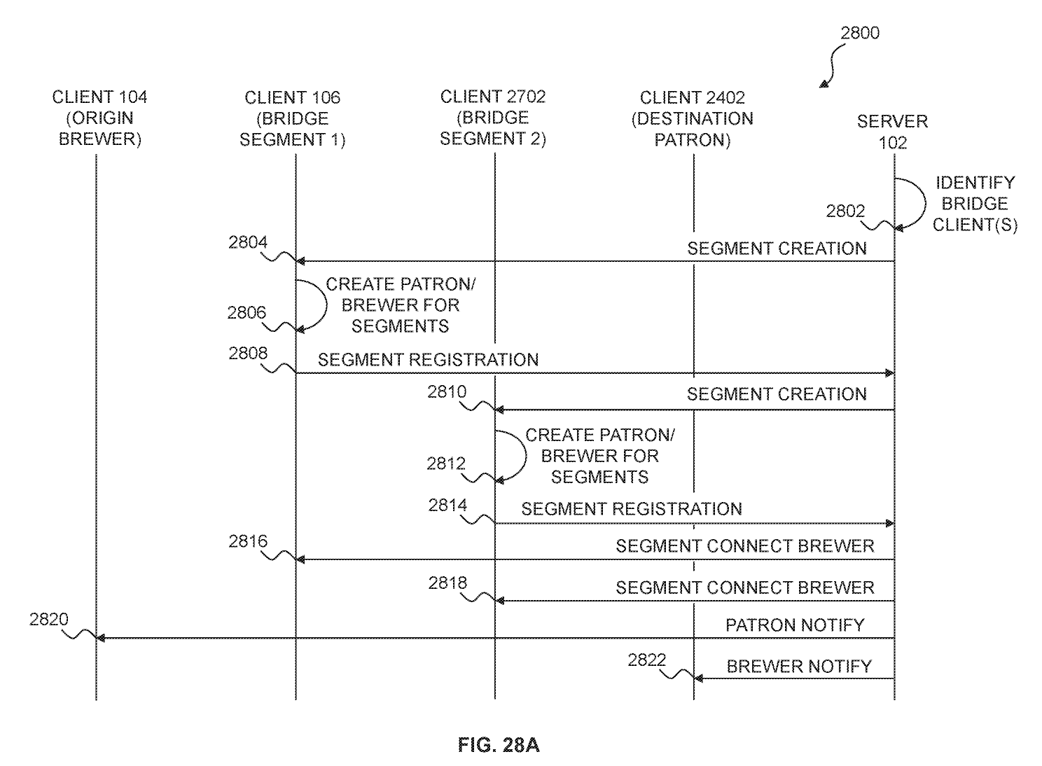

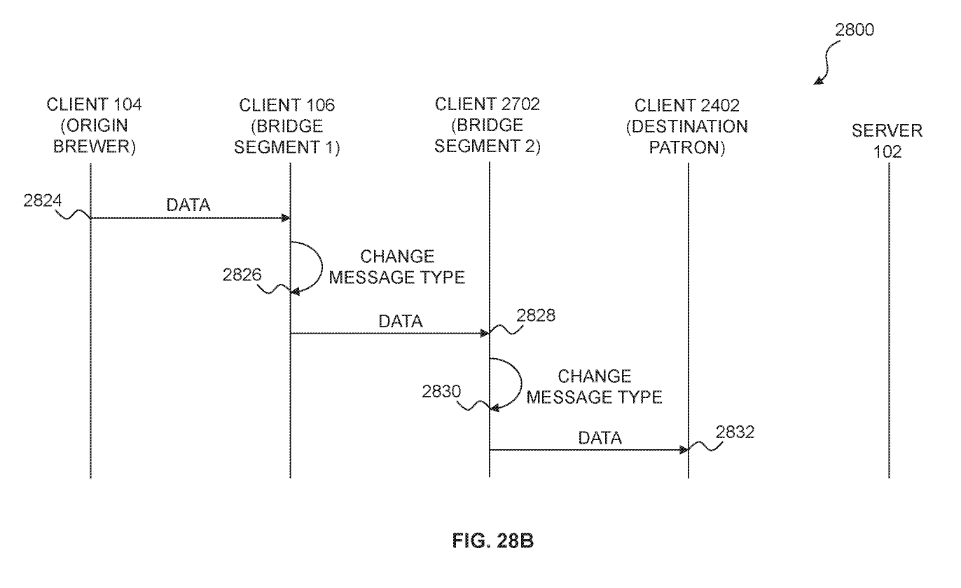

Referring to FIGS. 28A and 28B, a sequence diagram 2800 illustrates one embodiment of a process by which the clients 106 and 2702 of FIG. 27 may be used to form a multi-segment bridge between the clients 104 and 2402 within the Pubkeeper system 2700. The internal behavior of the clients 104, 106, 2402, and 2702 is not illustrated as previous diagrams have described embodiments of such behavior. In addition, initial registration by the clients 104, 106, 2402, and 2702 with the server 102 has been omitted for purposes of clarity, as have the brew registration messages by the clients 106 and 2702 (if different from the initial registration messages) and the segment registration by the server (e.g., step 2612 of FIG. 26).

Steps 2802, 2804, 2806, and 2808 correspond to steps 2604, 2606, 2608, and 2610 of FIG. 26, respectively, and are not described in detail in the present example. However, for the bridge-to-bridge communications between the clients 106 and 2702, the topic for the brewer of the client 106 is assigned as “709d9eb2361842deae963f01c0365ea6” in the present example, rather than the “example.topic” name used with respect to FIG. 26.

In step 2810, the server 102 sends a segment creation message to the client 2702. In the present example, the segment creation message instructs the client 2702 to create a ZeroMQ patron and a MQTT brewer that will be needed for the clients 106 and 2402, respectively. An example of the segment creation message is as follows:

```
  {
    ‘create_patron_details’: {
        ‘patron_id’: ‘409a7bcd09204691922bc77a50b769e4’,
        ‘prev_brewer_id’: ‘50176f68a6cf4fc38dfbb0e4e2c3f2c1’,
        ‘brew’: {
              ‘publisher_url’: ‘tcp://127.0.0.1:9097’,
                ‘name’: ‘zmq’
        },
        ‘topic’: ‘709d9eb2361842deae963f01c0365ea6’,
    },
    ‘create_brewer_details’: {
        ‘brewer_id’: ‘78c3b261942f44bd894bbddda7de497b’.
        ‘brew_name’: ‘mqtt’,
        ‘topic’: ‘example.topic’,
    },
    ‘segment_id’: ‘5a6f954a68f54de4b3629b5a1110f84e’,
}
```

As shown, the segment creation message includes patron details for the bridge's patron, brewer details for the bridge's brewer, and a unique segment identifier. The patron details include a patron identifier that is assigned by the server 102, the brewer from which the patron will receive information (e.g., the brewer of the bridge client 106), the brew that is used by the previous brewer and any relevant information so that the patron can subscribe to that brewer, and the topic name. For purposes of example, the topic name that has been assigned to the brewer of the bridge 106 (e.g., in step 2804) is “709d9eb2361842deae963f01c0365ea6.” Accordingly, the topic to which the patron of the bridge client 2702 is to subscribe is “709d9eb2361842deae963f01c0365ea6.” The brewer details include a brewer identifier that is assigned by the server 102, the name of the brew that the brewer is to use, and the topic. The topic is named “example.topic,” which is identical to the topic name used by the originating brewer of the client 104.

In step 2812, the client 2702 creates the segment patron needed to receive information from the bridge client 106 and the segment brewer needed to publish information for the client 2402. In step 2814, the brewer and patron on the client 2702 are registered with the server 102 for the segment identifier provided in the segment creation message of step 2810. An example of a segment registration message for the client 2702 is as follows:

```
  {
    ‘brewer_brew’: {
        ‘publisher_url’: ‘tcp://127.0.0.1:9171’,
        ‘name’: ‘mqtt’
    },
    ‘patron_brew’: {
        ‘name’: ‘zmq’
    },
    ‘segment_id’: ‘5a6f954a68f54de4b3629b5a1110f84e’
}
```

In steps 2816 and 2818, the server 102 sends segment connect brewer messages to the bridge clients 106 and 2702, respectively. Because the server 102 may not have all the needed information for the bridge clients until both bridge clients have created their respective brewers, the segment connect brewer message are sent following the receipt of the segment registration messages by the server 102. An example of the segment connect brewer message for the client 106 is as follows:

```
{
  ‘patron_id’: ‘409a7bcd09204691922bc77a50b769e4’,
  ‘patron_brew’: {
        ‘name’: ‘zmq’
  },
  ‘segment_id’: ‘f9d43d33926147d9ac8be5dc0b0fc78e’}
```

This message informs the client 106 of the existence of the patron of the client 2702 and the brew used by that patron. It is noted that there is not an explicit brewer notify for the segment patron of the bridge client, as the brewer notification is an implicit part of the earlier segment creation message for that bridge client when the patron is created.

An example of the segment connect brewer message for the client 2702 is as follows:

```
{
  ‘patron_id’: ‘2708dd30f67b4b018f2817119adbdc5e’,
  ‘patron_brew’: {
        ‘name’: ‘mqtt’
  },
  ‘segment_id’: ‘5a6f954a68f54de4b3629b5a1110f84e’}
```

This message informs the client 2702 of the patron of the client 2402 and the brew used by that patron.

In steps 2820 and 2822, respectively, a patron notification is sent to the client 104 and a brewer notification is sent to the client 2402. It is understood that the segment connect brewer messages of steps 2816 and 2818, the patron notify of step 2820, and the brewer notify of step 2822 may be sent in a different order or simultaneously.

Following step 2622, the bridge segments are complete and data from the client 104 can be communicated to the client 2402. To accomplish this, data corresponding to the desired topic that is published by the client 104 is received by the client 106 in step 2826. In the present example, the data is received via Web Socket and is to be published via ZeroMQ. Accordingly, in step 2826, the client 106 prepares the data for ZeroMQ transmission. The data is published by the client 106 and received by the client 2702 in step 2828. In the present example, the data is received via ZeroMQ and is to be published by the client 2702 via MQTT. Accordingly, in step 2830, the client 2702 prepares the data for MQTT transmission. In step 2832, the data is sent to the client 2402.

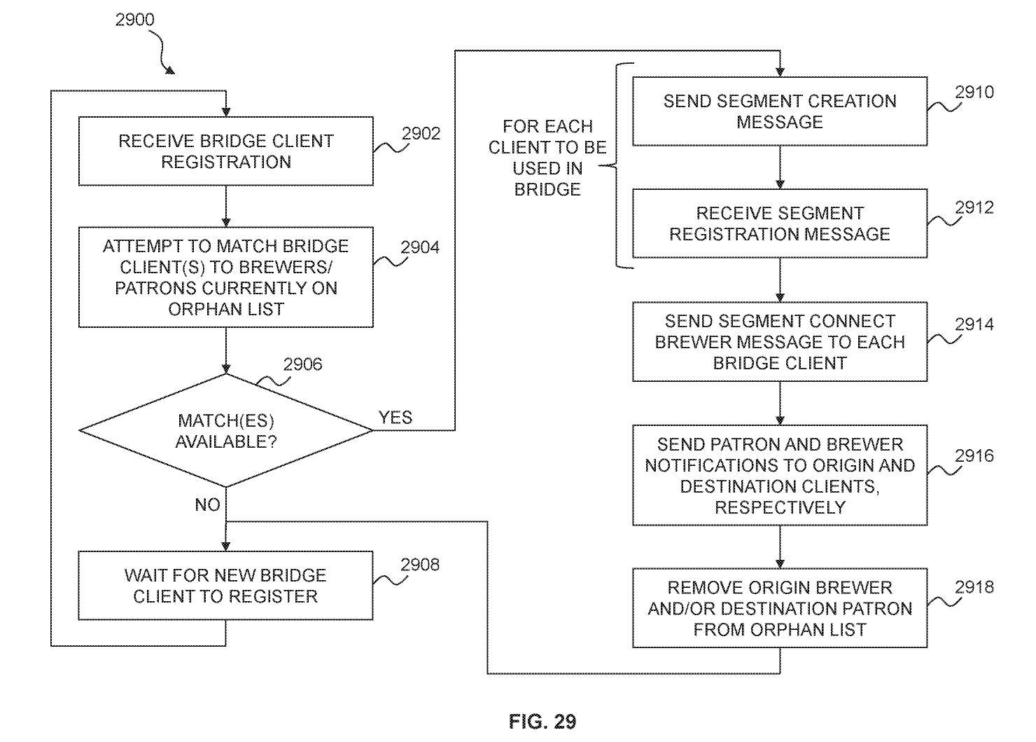

Referring to FIG. 29, a method 2900 illustrates one embodiment of a process that may be performed within a Pubkeeper system by a Pubkeeper server (e.g., the server 102 of FIGS. 25A or 27) to establish one or more bridge segments. In the present example, the server 102 maintains an orphan list with patrons and brewers that have no current match and for which there are no compatible bridge clients registered with the server 102.

In step 2902, a bridge client registers. As previously described, the registration provides information to the server 102, including the brews supported by the registering bridge client. In steps 2904 and 2906, the server 102 determines whether the newly registered bridge client can be used to link any of the patrons and/or brewers on the orphan list. If no matches are available (e.g., if the bridge client cannot be used with any of the current orphans), the method 2900 continues to step 2908. In step 2908, the server 102 waits for another bridge client to register, at which time the method 2900 returns to step 2902.

If a match is available (e.g., if the server 102 can build a bridge for an orphan using one or more available bridge clients), the method 2900 moves from step 2906 to step 2910. For each bridge client to be used in creating a bridge, the server 102 sends a segment creation message to the client in step 2910 and receives a segment registration message from the client in step 2912. As these messages have been described in previous embodiments, they are not described in detail in the present example.

In step 2914, the server 102 sends a segment connect brewer message to each bridge client. Although shown following the receipt of all segment registrations of step 2912, a segment connect brewer message may be sent to a bridge client once the server 102 has any needed information from a particular segment registration message, even if other segment registration messages have not been received. In step 2916, the server 102 sends patron and brewer notification messages to the origin and destination clients, respectively. Steps 2916 and 2918 may occur in a different order or simultaneously.

In step 2918, the server 102 removes the origin brewer and/or destination patron from the orphan list. Step 2918 may occur earlier in the method 2900 (e.g., immediately following step 2906), but is shown in its current location to ensure the orphan list is not updated until the bridge is in place.

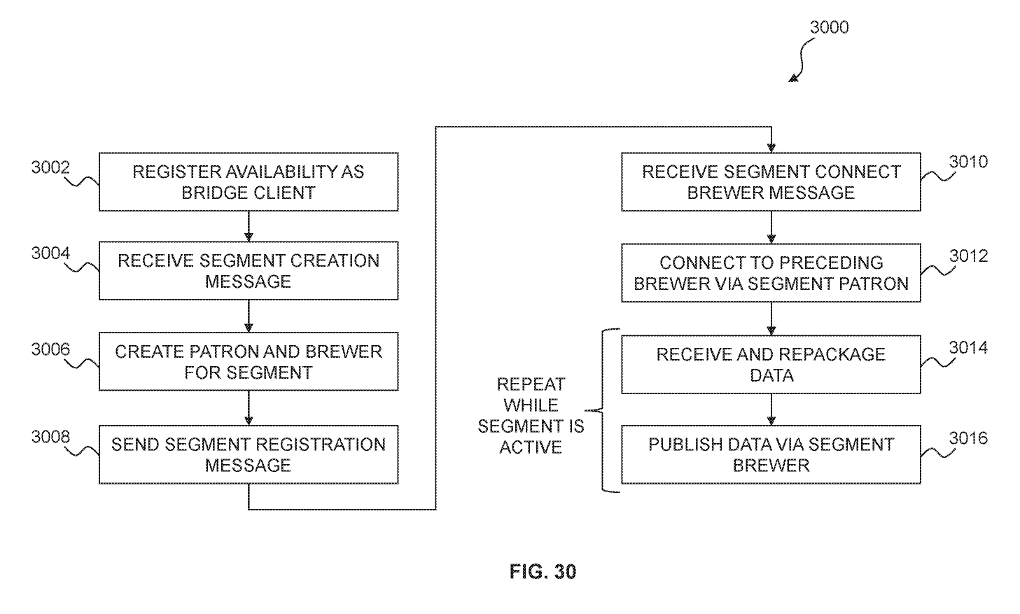

Referring to FIG. 30, a method 3000 illustrates one embodiment of a process that may be performed within a Pubkeeper system by a bridge client (e.g., the client 106 of FIGS. 24, 25A, 25B, or 27) to establish a bridge segment. The client 106 may be the only bridge segment (e.g., as in FIGS. 25A and 25B) or may be one of multiple bridge segments (e.g., as in FIG. 27).

In step 3002, the bridge client 106 registers with the server 102 as a bridge client, which includes notifying the server 102 of the brews that the client 106 has available. In step 3004, which may occur at any time following step 3002, the client 106 receives a segment creation message. As previously described, the segment creation message instructs the client 106 to create a patron and brewer for a segment using particular brews. In step 3006, the client 106 creates the segment patron and segment brewer using the defined brews. In step 3008, the client 106 sends a segment registration message to the server 102. The segment registration message notifies the server 102 that the client 106 has created the segment patron and segment brewer, and provides any patron/brewer specific information that may be needed by the server 102 while setting up the bridge.

In step 3010, the client 106 receives a segment connect brewer message. The segment connect brewer message activates the segment patron and provides any information that may be needed by the patron and/or brewer. In step 3012, the segment patron of the client 106 connects to the brewer of the previous client (either the origin client or a preceding bridge client). In step 3014, the client 106 receives and repackages data from the previous brewer. In step 3016, the client 106 republishes the data via the segment brewer.

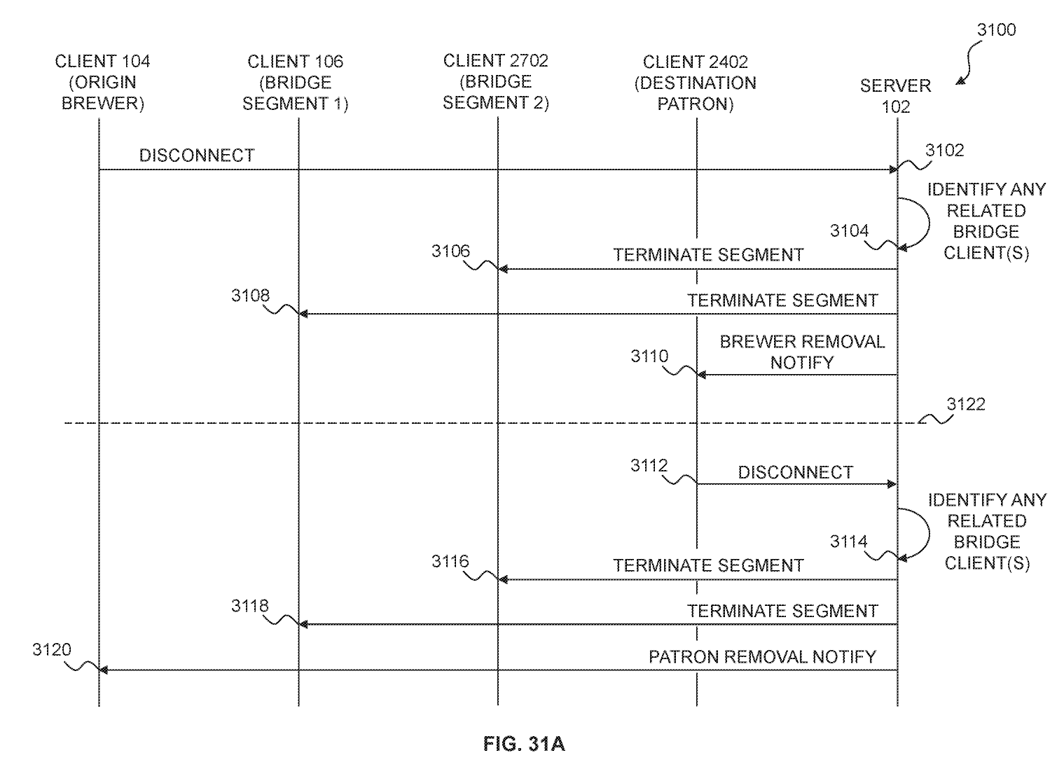

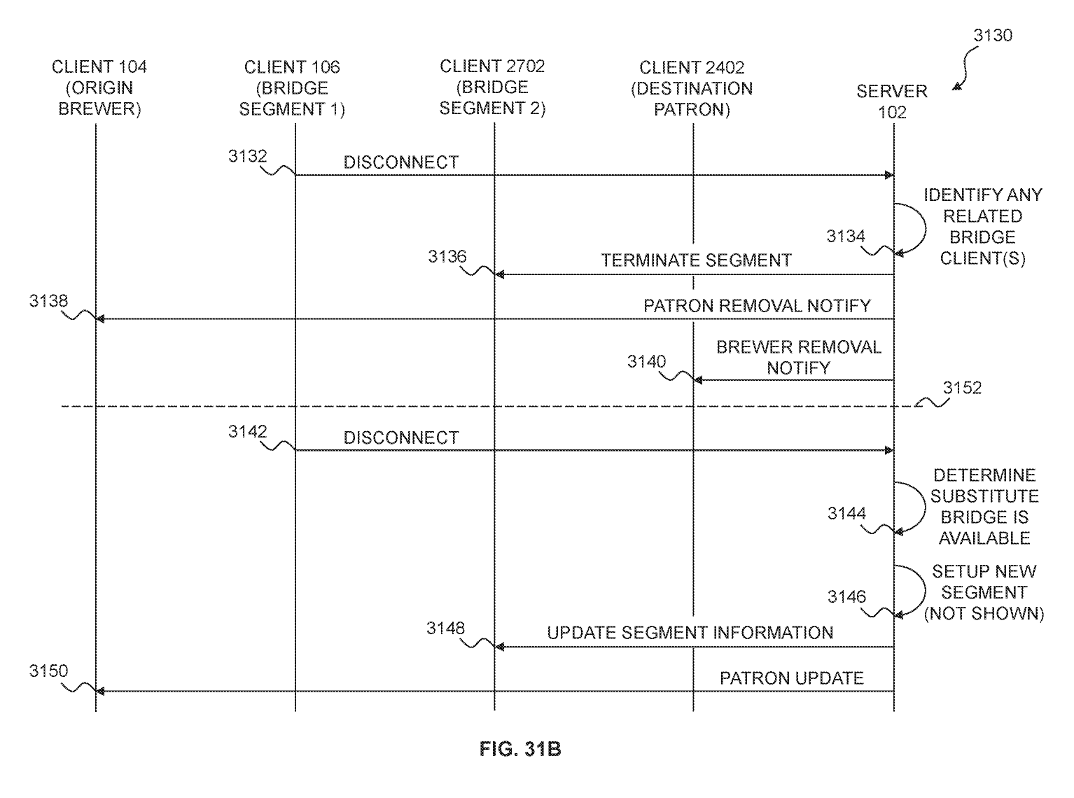

Referring to FIG. 31A, a sequence diagram 3100 illustrates embodiments of two different processes (separated by a line 3122) that may be used by the system 2700 of FIG. 27 to handle a disconnect by an origin brewer or a destination patron. The first process begins with step 3102 and illustrates an origin brewer disconnection. The second process begins with step 3112 and illustrates a destination patron disconnection. It is understood that if no initial disconnect message is sent to the server 102 (e.g., if the client 104 or the client 2402 crashes), the server 102 may detect the disconnect and perform the steps shown following a disconnect message. Although shown with two segments, it is understood that the sequence diagram 3100 is equally applicable to single segment bridges such as that shown in FIG. 25A.

In step 3102, the client 104 sends a disconnect message for the origin brewer. In step 3104, the server 102 identifies any bridge clients with related segments. In steps 3106 and 3108, the server 102 notifies the clients 2702 and 106, respectively, to terminate their corresponding segments. In step 3110, the server 102 sends a brewer removal notification to the client 2402 to inform the client 2402 that the brewer to which the destination patron was listening is no longer available. It is understood that the messages of steps 3106, 3108, and 3110 may occur in a different order or simultaneously.

In step 3112, the client 2402 sends a disconnect message for the destination patron. In step 3114, the server 102 identifies any bridge clients with related segments. In steps 3116 and 3118, the server 102 notifies the clients 2702 and 106, respectively, to terminate their corresponding segments. In step 3120, the server 102 sends a patron removal notification to the client 104 to inform the client 104 that the patron to which the origin brewer was publishing is no longer available. It is understood that the messages of steps 3116, 3118, and 3120 may occur in a different order or simultaneously.

Referring to FIG. 31B, a sequence diagram 3130 illustrates embodiments of two different processes (separated by a line 3152) that may be used by the system 2700 of FIG. 27 to handle a disconnect by a bridge client. The first process begins with step 3132 and illustrates a disconnection that automatically results in the entire bridge being terminated. The second process begins with step 3142 and illustrates a disconnection in which the server 102 attempts to repair the bridge. It is understood that if no initial disconnect message is sent to the server 102 (e.g., if the bridge client 106 or 2702 crashes), the server 102 may detect the disconnect and perform the steps shown following a disconnect message. Although shown with two segments, it is understood that the sequence diagram 3130 is equally applicable to single segment bridges such as that shown in FIG. 25A.

In step 3132, the bridge client 106 sends a disconnect message for the bridge segment. The disconnect message may indicate that the client 106 is disconnecting entirely or that the segment is being terminated by the client 106. In step 3134, the server 102 identifies any bridge clients with related segments. In step 3136, the server 102 notifies the client 2702 to terminate the corresponding segment. In step 3138, the server 102 sends a patron removal notification to the client 104. In step 3140, the server 102 sends a brewer removal notification to the client 2402. It is understood that the messages of steps 3136, 3138, and 3140 may occur in a different order or simultaneously.

In step 3142, the bridge client 106 sends a disconnect message for the bridge segment. The disconnect message may indicate that the client 106 is disconnecting entirely or that the segment is being terminated by the client 106. In step 3144, the server 102 determines that a substitute bridge is available. In step 3146, the server 102 sets up a new segment using the substitute bridge (not shown). As the substitute segment is created as a regular segment and such setup steps have been previously described, the setup process is not shown in FIG. 31B.

In step 3148, the server 102 sends a segment update to the bridge client 2702 so that the client 2702 will have the information for the new segment (e.g., the brewer information needed by the segment patron of the client 2702). In step 3150, the server 102 sends a patron update to the client 104. It is understood that the messages of steps 3148 and 3150 may occur in a different order or simultaneously.

If the disconnect of step 3142 was sent by the bridge client 2702, the message of step 3148 would be sent to the client 106 and a brewer update would be sent to the client 2402. It is understood that updates may be sent to all clients involved in the bridge or just to clients that are adjacent to, or otherwise affected by the introduction of, a substitute node. If the determination of step 3144 does not identify a substitute bridge client, the bridge would be terminated as illustrated in steps 3134 through 3140.

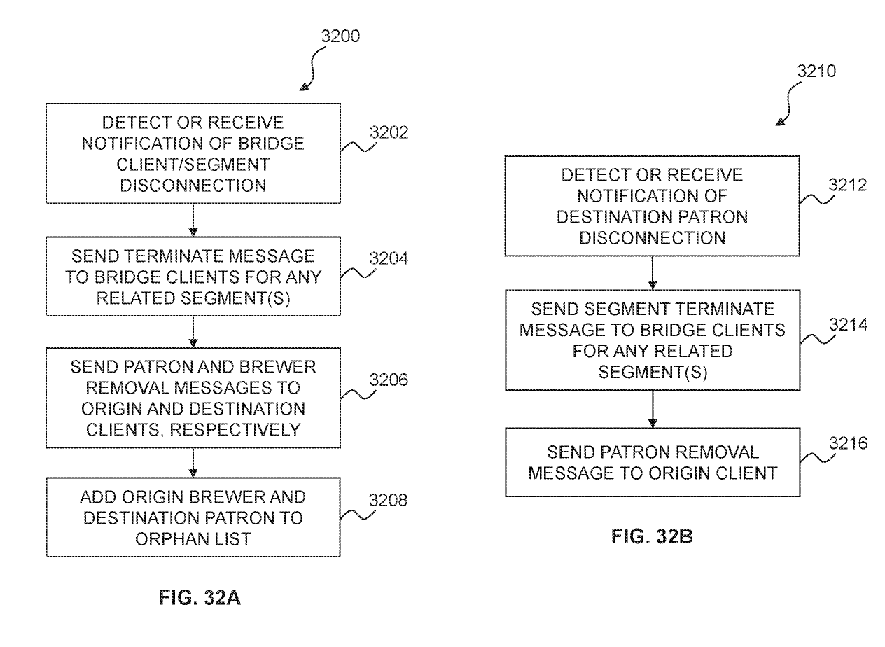

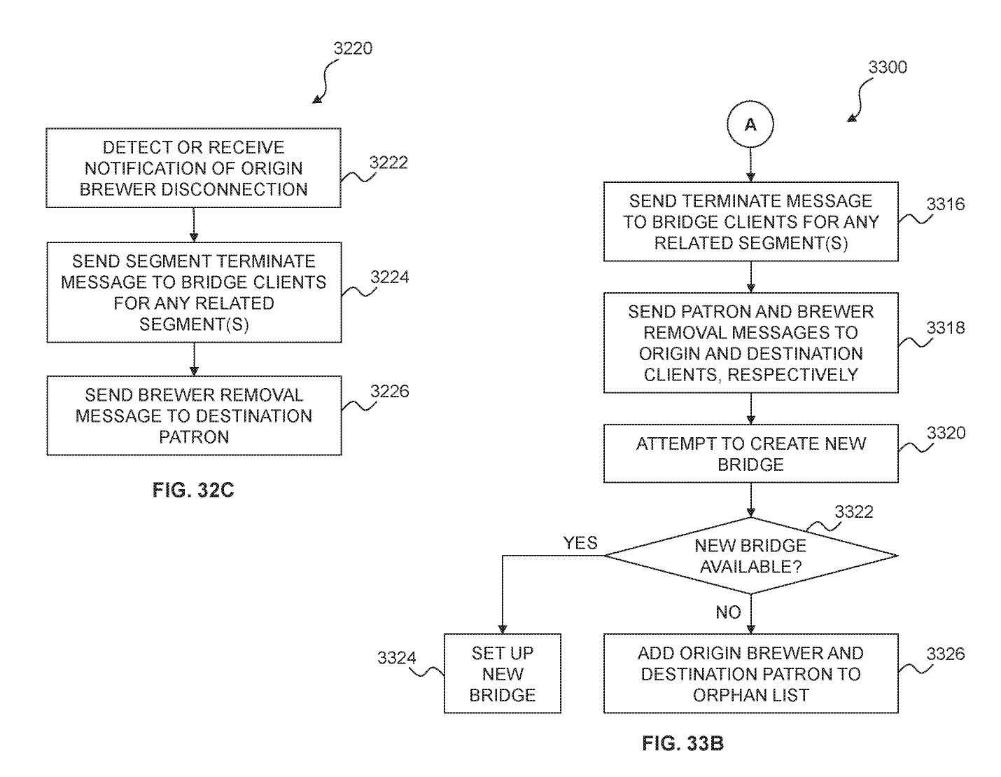

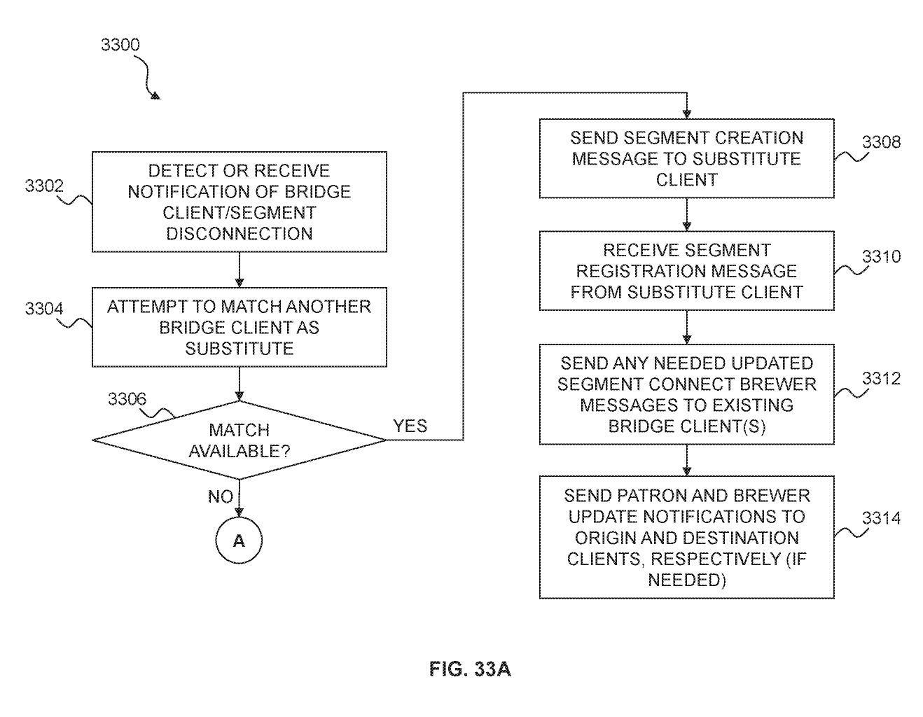

Referring to FIG. 32A, a method 3200 illustrates one embodiment of a process that may be performed within a Pubkeeper system by a server (e.g., the server 102 of FIGS. 24, 25A, or 27) when a bridge client disconnects. The method 3200 may be used with both single segment and multi-segment bridges. In the present example, the entire bridge is terminated if any segment disconnects.

In step 3202, the server 102 detects that a bridge client or segment has disconnected or receives a notification of such a disconnection. In step 3204, the server 102 sends a segment termination message to any bridge clients that are providing other segments for the bridge. In step 3206, the server 102 sends a patron removal message to the client with the origin brewer and a brewer removal message to the client with the destination patron. In step 3208, the origin brewer and destination patron are added to the orphan list.

Referring to FIG. 32B, a method 3210 illustrates one embodiment of a process that may be performed within a Pubkeeper system by a server (e.g., the server 102 of FIGS. 24, 25A, or 27) when a bridge's destination patron disconnects. The method 3210 may be used with both single segment and multi-segment bridges.

In step 3212, the server 102 detects that the destination patron has disconnected or receives a notification of such a disconnection. In step 3214, the server 102 sends a termination message to any bridge clients that are providing other segments for the bridge. In step 3216, the server 102 sends a patron removal message to the client with the origin brewer.

Referring to FIG. 32C, a method 3220 illustrates one embodiment of a process that may be performed within a Pubkeeper system by a server (e.g., the server 102 of FIGS. 24, 25A, or 27) when a bridge's origin brewer disconnects. The method 3220 may be used with both single segment and multi-segment bridges.

In step 3222, the server 102 detects that the origin brewer has disconnected or receives a notification of such a disconnection. In step 3224, the server 102 sends a termination message to any bridge clients that are providing other segments for the bridge. In step 3226, the server 102 sends a brewer removal message to the client with the destination patron.

Referring to FIGS. 33A and 33B, a method 3300 illustrates one embodiment of a process that may be performed within a Pubkeeper system by a server (e.g., the server 102 of FIGS. 24, 25A, or 27) when a bridge client disconnects. As disconnection by the origin brewer or destination patron results in the entire bridge being terminated, the present example applies only when a bridge segment disconnects. The method 3300 may be used with both single segment and multi-segment bridges.

In step 3302, the server 102 detects that a bridge client or segment has disconnected or receives a notification of a disconnection. It is noted that a segment may disconnect even if the bridge client supporting that segment remains online if, for example, one of the brews supporting the segment enters an error state. In step 3304, the server 102 attempts to locate another bridge client to serve as a substitute for the disconnected segment. For example, if the segment was supporting ZeroMQ to MQTT, the server 102 may determine whether another bridge client is available that can support a ZeroMQ to MQTT segment. If a match is found, as determined in step 3306, the method moves to step 3308.

In step 3308, the server 102 sends a segment creation message to the substitute bridge client. In step 3310, the server 102 receives a segment registration message from the substitute bridge. In step 3312, the server 102 sends updated segment brewer connect messages to existing bridge clients as needed. In some embodiments the server 102 may send segment brewer connect messages to all existing bridge clients, while in other embodiments the server 102 may only send necessary segment brewer connect messages (e.g., to the bridge client preceding the substitute bridge client). It is understood that step 3312 may be omitted entirely when dealing with single segment bridges as no other bridge clients exist.

In step 3314, patron and/or brewer update messages may be sent to the origin and destination clients, respectively, as needed. For example, if the new segment immediately follows the origin brewer in the bridge, the origin brewer may be updated with the new segment's patron information. Similarly, if the destination patron immediately follows the new segment, the destination patron may be updated with the new segment's brewer information. If the new segment is between two bridge clients, then neither the origin brewer nor the destination patron may be updated. However, in some embodiments, updates may be sent to the origin brewer and the destination patron even if such updates are not needed. For example, this may be done to maintain messaging consistency and/or to account for possible scenarios in which such updates are useful.

Returning to step 3306, if no match is found, the method 3300 moves to step 3316 rather than step 3308. In step 3316, the server 102 sends termination messages for any related segments because there is no substitute for the disconnected segment. In step 3318, the server 102 sends a patron removal message to the client with the origin brewer and a brewer removal message to the client with the destination patron.

At this point, the bridge has been completely terminated and the origin brewer and destination patron may be added to the orphan list. However, in the present example, the server 102 attempts to create a new bridge in step 3320. For example, even though the disconnected segment cannot be replaced, another bridge may be available that does not need the brews provided by the missing segment. If a new bridge is available as determined in step 3322, the method 3300 moves to step 3324. In step 3324, the new bridge is created. If no new bridge is available, the method 3300 moves to step 3326 and the origin brewer and destination patron are added to the orphan list.

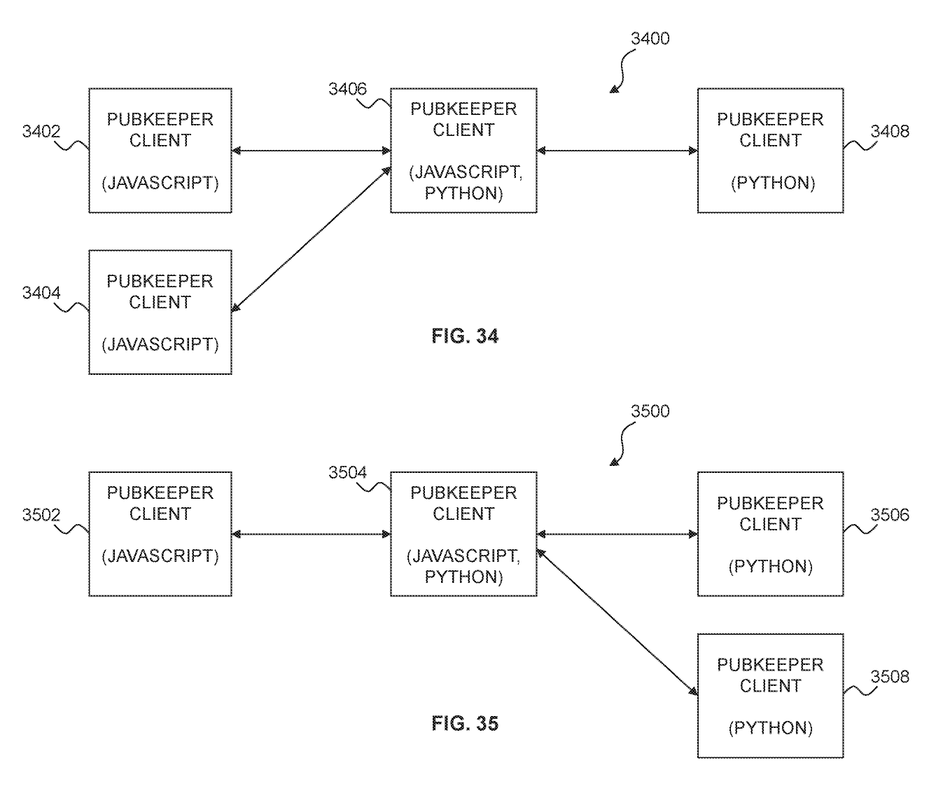

Referring to FIG. 34, one embodiment of a system 3400 includes clients 3402, 3404, 3406, and 3408 and illustrates multiple brewers publishing to a single bridge client. The clients 3402 and 3404 are both publishing via a JavaScript brew to the client 3406, which is serving as a bridge client. The client 3406 is publishing the received data via Python to the client 3408.

Referring to FIG. 35, one embodiment of a system 3500 includes clients 3502, 3504, 3506, and 3508 and illustrates multiple patrons listening to a single bridge client. The client 3502 is publishing via a JavaScript brew to the client 3504, which is serving as a bridge client. The client 3504 is publishing via Python to the clients 3506 and 3508. In some embodiments, the server 102 (FIGS. 25A and 27) may use the client 3504 to broadcast a single topic to multiple patrons (e.g., the patrons of the client 3506 and 3508) in order to avoid the need for multiple bridges for a single topic.

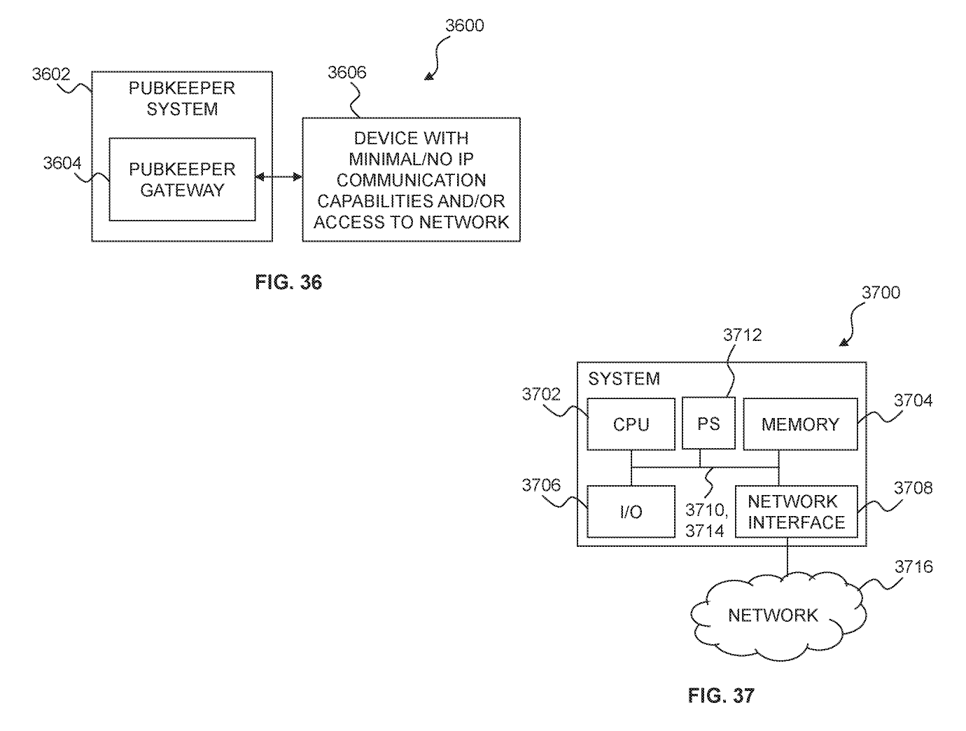

Referring to FIG. 36, one embodiment of a system 3600 includes a Pubkeeper system 3602 containing a gateway 3604. The gateway 3604 is coupled to a device 3606. The device 3606 may lack or have minimal IP communications capabilities, and/or may have no or limited access to a network necessary to communicate as a client within the Pubkeeper system 3602.

Referring to FIG. 37, one embodiment of a device 3700 is illustrated. The device 3700 is one possible example of one or more of the devices 108, 110, and 112 of FIG. 1A. The device 3700 may include a controller (e.g., a processor/central processing unit (“CPU”)) 3702, a memory unit 3704, an input/output (“I/O”) device 3706, and a network interface 3708. The components 3702, 3704, 3706, and 3708 are interconnected by a data transport system (e.g., a bus) 3710. A power supply (PS) 3712 may provide power to components of the device 3700 via a power transport system 3714 (shown with data transport system 3710, although the power and data transport systems may be separate).

It is understood that the device 3700 may be differently configured and that each of the listed components may actually represent several different components. For example, the CPU 3702 may actually represent a multi-processor or a distributed processing system; the memory unit 3704 may include different levels of cache memory, main memory, hard disks, and remote storage locations; the I/O device 3706 may include monitors, keyboards, touchpads, and the like; and the network interface 3708 may include one or more network chips or cards providing one or more wired and/or wireless connections to a network 3716. Therefore, a wide range of flexibility is anticipated in the configuration of the device 3700, which may range from a single physical platform configured primarily for a single user or autonomous operation to a distributed multi-user platform such as a cloud computing system.

The device 3700 may use any operating system (or multiple operating systems), including various versions of operating systems provided by Microsoft (such as WINDOWS), Apple (such as MacOS), UNIX, and LINUX, and may include operating systems specifically developed for handheld devices (e.g., i0S, Android, Blackberry, and/or Windows Phone), personal computers, servers, and other computing platforms depending on the use of the device 3700. The operating system, as well as other instructions (e.g., for telecommunications and/or other functions provided by the device), may be stored in the memory unit 3704 and executed by the processor 3702. For example, if the device 3700 is the device 110, the memory unit 3704 may include instructions for providing the Pubkeeper server 102 and/or client 104 and for performing some or all of the processes described herein.

The network 3716 (which may be the network(s) 114 of FIG. 1A) may be a single network or may represent multiple networks, including networks of different types, whether wireless or wireline. For example, the device 3700 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 3700 with external devices.

Exemplary network, system, and connection types include the internet, WiMax, local area networks (LANs) (e.g., IEEE 802.11a and 802.11g wi-fi networks), digital audio broadcasting systems (e.g., HD Radio, T-DMB and ISDB-TSB), terrestrial digital television systems (e.g., DVB-T, DVB-H, T-DMB and ISDB-T), WiMax wireless metropolitan area networks (MANs) (e.g., IEEE 802.16 networks), Mobile Broadband Wireless Access (MBWA) networks (e.g., IEEE 802.20 networks), Ultra Mobile Broadband (UMB) systems, Flash-OFDM cellular systems, and Ultra wideband (UWB) systems. Furthermore, the present disclosure may be used with communications systems such as Global System for Mobile communications (GSM) and/or code division multiple access (CDMA) communications systems. Connections to such networks may be wireless or may use a line (e.g., digital subscriber lines (DSL), cable lines, and fiber optic lines).

Accordingly, in one embodiment, the present disclosure describes a client configured to operate within a messaging system that enables the use of a plurality of message types, the client comprising system functionality that enables the client to operate within the messaging system in order to send and receive messages for an application that is using the client; at least one brew that is configured to manage one of the plurality of message types for the client by interacting with a module that encapsulates a process for sending and receiving messages within the messaging system that are compliant with the message type, wherein the brew provides a brew interface for interaction with at least one brewer of the client, and wherein the brew interface is standardized across all brews within the client to enable any brewers of the client to send messages to the brews in an identical manner regardless of the process encapsulated by the module that is being managed by each brew; and at least one brewer that is associated with a topic and provides a brewer interface for receiving outgoing data corresponding to the topic from the application, wherein the brewer is configured to send the outgoing data to the brew, and wherein the brewer interface is standardized across all brewers within the client to enable the application to send messages to the brewers in an identical manner.

In some embodiments, the brew is configurable to push data directly to the application.

In some embodiments, the brewer is configured to notify at least one of the brews that a patron corresponding to the topic has been registered within the messaging system by another client, wherein the brew establishes a connection via the module with a corresponding brew and module of the other client based on the notification in order to send data for the topic to the other client.

In some embodiments, the client further comprises at least one patron that is associated with a topic and is configured to notify at least one of the brews that a brewer corresponding to the topic has been registered within the messaging system by another client, wherein the brew establishes a connection via the module with a corresponding brew and module of the other client based on the notification in order to receive data for the topic from the other client.

In some embodiments, the client further comprises at least one patron that is associated with a topic and configured to receive incoming data corresponding to the topic from the brew, wherein the patron provides a patron interface from which the application can pull the incoming data from the patron, and wherein the patron interface is standardized across all patrons within the client.

In some embodiments, the patron is configurable to push data to the application.

In some embodiments, the module is configured to send the outgoing data directly to a module of another client in a peer-to-peer manner.

In some embodiments, the module is configured to send the outgoing data to a server for retrieval by a module of another client.

In some embodiments, the brew is configured to perform processing to format the outgoing data and the incoming data.

In some embodiments, the brew is configured to perform processing to encrypt the outgoing data and decrypt the incoming data.

In another embodiment, the present disclosure describes a client configured to operate within a messaging system that enables the use of a plurality of message types, the client comprising system functionality that enables the client to operate within the messaging system in order to send and receive messages for an application that is using the client; at least one brew that is configured to manage one of the plurality of message types for the client by interacting with a module that encapsulates a process for sending and receiving messages within the messaging system that are compliant with the message type, wherein the brew provides a brew interface for interaction with at least one patron of the client, wherein the brew interface is standardized across all brews within the client to enable any patrons of the client to interact with the brews in an identical manner regardless of the process encapsulated by the module that is being managed by each brew; and at least one patron that is associated with a topic and is configured to notify at least one of the brews that a brewer corresponding to the topic has been registered within the messaging system by another client, wherein the brew establishes a connection via the module with a corresponding brew and module of the other client based on the notification in order to receive data for the topic from the other client.

In some embodiments, the patron provides a patron interface from which the application can pull the incoming data from the patron, and wherein the patron interface is standardized across all patrons within the client.

In some embodiments, the patron is configurable to push data to the application.

In some embodiments, the brew is configurable to push data directly to the application.

In some embodiments, the client further comprises at least one brewer that is associated with a topic and provides a brewer interface for receiving outgoing data corresponding to the topic from the application, wherein the brewer is configured to send the outgoing data to the brew, and wherein the brewer interface is standardized across all brewers within the client.

In some embodiments, the brewer is configured to notify at least one of the brews that a patron corresponding to the topic has been registered within the messaging system by another client, wherein the brew establishes a connection via the module with a corresponding brew and module of the other client based on the notification in order to send data for the topic to the other client.

In some embodiments, the module is configured to send the outgoing data directly to a module of another client in a peer-to-peer manner.

In some embodiments, the module is configured to send the outgoing data to a server room for retrieval by a module of another client.

In some embodiments, the brew is configured to perform processing to format the outgoing data and the incoming data.

In some embodiments, the brew is configured to perform processing to encrypt the outgoing data and decrypt the incoming data.

In another embodiment, the present disclosure describes a system for enabling the management of a plurality of message types through a common interface, the system comprising a server configured to manage messaging information for a plurality of clients; and the plurality of clients, wherein each client includes a plurality of brews that are registered with the client, wherein each brew is configured to manage one of a plurality of message types for the client by interacting with a module that encapsulates a process for sending and receiving messages of the message type, and wherein the brew provides an interface between the module and a plurality of brewers and patrons to enable sending and receiving data, respectively, via the module in compliance with the message type, and wherein the brew is configurable to send incoming data directly to an application that is using the client; the plurality of brewers, wherein each brewer is associated with at least one topic and provides an interface for receiving outgoing data corresponding to the topic from the application and sending the outgoing data to at least one of the plurality of brews; and the plurality of patrons that are registered with the client, wherein each patron is associated with a topic and is configurable to provide an interface for receiving incoming data corresponding to a topic from at least one of the plurality of brews and sending the incoming data to the application.

In another embodiment, the present disclosure describes a method for use by a client in a messaging system that supports multiple message types, the method comprising starting, by an application, a client process in order to launch the client; creating and configuring at least one brew for use by the client, wherein the brew is configured to manage one of a plurality of message types for the client by interacting with a module that encapsulates a process for sending and receiving messages of the message type; creating and configuring the module corresponding to each brew; creating and configuring at least one of a brewer for sending outgoing data or a patron for receiving incoming data; registering the at least one brewer or patron with a server of the messaging system; receiving a list including at least one patron or brewer from the server; and performing at least one of sending outgoing data for the application or receiving incoming data for the application.

In some embodiments, the client includes a brewer, the method further comprising receiving a notification of a new patron at another client within the messaging system; notifying the brew of the new patron; and connecting, by the brew via the module, with a module and brew of the other client in order to send outgoing data from the application to the other client.

In some embodiments, the client includes a patron, the method further comprising receiving a notification of a new brewer at another client within the messaging system; notifying the brew of the new brewer; and connecting, by the brew via the module, with a module and brew of the other client in order to receive incoming data for the application from the other client.

In another embodiment, the present disclosure describes a method for creating a bridge segment within a messaging system that supports the use of a plurality of message types, the method comprising maintaining an orphan list that contains at least one pair of incompatible brewers and patrons within the messaging system, wherein each pair on the orphan list includes a brewer configured to publish data for a topic and a list of all message types supported by the client corresponding to the brewer; and a patron configured to subscribe to the topic and a list of all message types supported by the client corresponding to the patron, wherein the patron cannot communicate directly with the brewer because the clients corresponding to the brewer and the patron do not share a compatible message type; identifying, for a first pair on the orphan list formed by a first brewer and a first patron, a bridge client that can communicate with a first client corresponding to the first brewer and a second client corresponding to the first patron, wherein the first client uses a first message type and the second client uses a second message type; instructing the bridge client to create a bridge segment by starting a segment patron that uses the first message type and a segment brewer that uses the second message type, wherein the bridge patron and the bridge client are linked together within the bridge client; receiving a notification from the bridge client that the bridge segment has been created; and notifying the first client of the bridge patron and the second client of the bridge brewer, wherein communication between the first and second clients is enabled via a channel formed between the first brewer and the bridge patron using the first message type, the bridge segment, and the bridge brewer and the first patron using the second message type.

In another embodiment, the present disclosure describes a method for creating a bridge between incompatible clients within a messaging system that supports the use of a plurality of message types, the method comprising maintaining an orphan list that stores pairs of incompatible brewers and patrons that exist within the messaging system, wherein each pair on the orphan list includes an origin brewer configured to publish data for a topic and a list of all message types supported by a client corresponding to the origin brewer; and a destination patron configured to subscribe to the topic and a list of all message types supported by the client corresponding to the destination patron, wherein the destination patron cannot communicate directly with the origin brewer because the clients corresponding to the origin brewer and the destination patron do not share a compatible message type; identifying a plurality of bridge clients available within the messaging system that can be used to create a bridge between the origin brewer and the destination patron of a first pair on the orphan list, wherein the bridge will include a plurality of bridge segments that are each provided by one of the bridge clients, and wherein each of the bridge clients supports two different message types needed for the bridge; for each bridge segment, instructing the corresponding bridge client to create the bridge segment by starting a segment patron that uses the one of the two message types that is needed as an input and a segment brewer that uses the other of the two message types that is needed as an output, wherein the segment patron and the segment client are linked together within the bridge client; for each bridge segment, notifying each bridge client of an immediately preceding brewer in the bridge to which the segment patron should subscribe and an immediately following patron in the bridge that is to receive data published by the segment brewer; and notifying the origin brewer of the following segment patron and notifying the destination patron of the preceding segment brewer.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

What is claimed is:

1. A client configured to operate within a messaging system that enables the use of a plurality of message types, the client comprising:
system functionality that enables the client to operate within the messaging system in order to send and receive messages for an application that is using the client;
at least one brew that is configured to manage one of the plurality of message types for the client by interacting with a module that encapsulates a process for sending and receiving messages within the messaging system that are compliant with the message type, wherein the brew provides a brew interface for interaction with at least one brewer of the client, and wherein the brew interface is standardized across all brews within the client to enable any brewers of the client to send messages to the brews in an identical manner regardless of the process encapsulated by the module that is being managed by each brew; and
at least one brewer that is associated with a topic and provides a brewer interface for receiving outgoing data corresponding to the topic from the application, wherein the brewer is configured to send the outgoing data to the brew, and wherein the brewer interface is standardized across all brewers within the client to enable the application to send messages to the brewers in an identical manner.

2. The client of claim 1 wherein the brew is configurable to push data directly to the application.

3. The client of claim 1 wherein the brewer is configured to notify at least one of the brews that a patron corresponding to the topic has been registered within the messaging system by another client, wherein the brew establishes a connection via the module with a corresponding brew and module of the other client based on the notification in order to send data for the topic to the other client.

4. The client of claim 1 further comprising at least one patron that is associated with a topic and is configured to notify at least one of the brews that a brewer corresponding to the topic has been registered within the messaging system by another client, wherein the brew establishes a connection via the module with a corresponding brew and module of the other client based on the notification in order to receive data for the topic from the other client.

5. The client of claim 1 further comprising at least one patron that is associated with a topic and configured to receive incoming data corresponding to the topic from the brew, wherein the patron provides a patron interface from which the application can pull the incoming data from the patron, and wherein the patron interface is standardized across all patrons within the client.

6. The client of claim 5 wherein the patron is configurable to push data to the application.

7. The client of claim 1 wherein the module is configured to send the outgoing data directly to a module of another client in a peer-to-peer manner.

8. The client of claim 1 wherein the module is configured to send the outgoing data to a server for retrieval by a module of another client.

9. The client of claim 1 wherein the brew is configured to perform processing to format the outgoing data and the incoming data.

10. The client of claim 1 wherein the brew is configured to perform processing to encrypt the outgoing data and decrypt the incoming data.

11. A client configured to operate within a messaging system that enables the use of a plurality of message types, the client comprising:
system functionality that enables the client to operate within the messaging system in order to send and receive messages for an application that is using the client;
at least one brew that is configured to manage one of the plurality of message types for the client by interacting with a module that encapsulates a process for sending and receiving messages within the messaging system that are compliant with the message type, wherein the brew provides a brew interface for interaction with at least one patron of the client, wherein the brew interface is standardized across all brews within the client to enable any patrons of the client to interact with the brews in an identical manner regardless of the process encapsulated by the module that is being managed by each brew; and
at least one patron that is associated with a topic and is configured to notify at least one of the brews that a brewer corresponding to the topic has been registered within the messaging system by another client, wherein the brew establishes a connection via the module with a corresponding brew and module of the other client based on the notification in order to receive data for the topic from the other client.

12. The client of claim 11 further wherein the patron provides a patron interface from which the application can pull the incoming data from the patron, and wherein the patron interface is standardized across all patrons within the client.

13. The client of claim 12 wherein the patron is configurable to push data to the application.

14. The client of claim 11 wherein the brew is configurable to push data directly to the application.

15. The client of claim 11 further comprising at least one brewer that is associated with a topic and provides a brewer interface for receiving outgoing data corresponding to the topic from the application, wherein the brewer is configured to send the outgoing data to the brew, and wherein the brewer interface is standardized across all brewers within the client.

16. The client of claim 11 wherein the brewer is configured to notify at least one of the brews that a patron corresponding to the topic has been registered within the messaging system by another client, wherein the brew establishes a connection via the module with a corresponding brew and module of the other client based on the notification in order to send data for the topic to the other client.

17. The client of claim 11 wherein the module is configured to send the outgoing data directly to a module of another client in a peer-to-peer manner.

18. The client of claim 11 wherein the module is configured to send the outgoing data to a server room for retrieval by a module of another client.

19. The client of claim 11 wherein the brew is configured to perform processing to format the outgoing data and the incoming data.

20. A system for enabling the management of a plurality of message types through a common interface, the system comprising:
a server configured to manage messaging information for a plurality of clients; and
the plurality of clients, wherein each client includes
a plurality of brews that are registered with the client, wherein each brew is configured to manage one of a plurality of message types for the client by interacting with a module that encapsulates a process for sending and receiving messages of the message type, and wherein the brew provides an interface between the module and a plurality of brewers and patrons to enable sending and receiving data, respectively, via the module in compliance with the message type, and wherein the brew is configurable to send incoming data directly to an application that is using the client;
the plurality of brewers, wherein each brewer is associated with at least one topic and provides an interface for receiving outgoing data corresponding to the topic from the application and sending the outgoing data to at least one of the plurality of brews; and
the plurality of patrons that are registered with the client, wherein each patron is associated with a topic and is configurable to provide an interface for receiving incoming data corresponding to a topic from at least one of the plurality of brews and sending the incoming data to the application.
